(19) United States
(12) Patent Application Publication
(10) Pub. No.: US 2011/0078272 A1
(43) Pub. Date: Mar. 31, 2011

(54) COMMUNICATION TERMINAL DEVICE AND COMMUNICATION SYSTEM USING SAME

(75) Inventors: Naoyuki Tamai, Osaka (JP); Yujiro Fukui, Osaka (JP); Koji Goto, Osaka (JP); Atsuhiko Kanda, Osaka (JP); Hiroshige Okamoto, Osaka (JP)

(73) Assignee: KYOCERA CORPORATION, Kyoto-shi, Kyoto (JP)

(21) Appl. No.: 12/995,119

(22) PCT Filed: Mar. 29, 2010
(86) PCT No.: PCT/JP2010/002233

§ 371 Date: Nov. 29, 2010

(30) Foreign Application Priority Data
Mar. 31, 2009 (JP) 2009-087935

(51) Int. Cl. G06F 15/16; G06F 3/041

(52) U.S. Cl. 709/206; 715/863

(57) ABSTRACT

The communication terminal device pertaining to the present invention has a touch panel, a display processing unit that displays information on the touch panel, a file identification unit that identifies a target file based on information displayed within a user specification range in the touch panel, the user specification range being specified by a user operation of the touch panel, and a file transmission unit that transmits the file identified by the file specification unit to an external device.

### TECHNICAL FIELD

The present invention relates to a communication terminal device having a touch panel.

### BACKGROUND ART

A communication terminal device having a function of sending and receiving electronic mails and being capable of attaching a file, such as an image file, to the electronic mail has been available.

When a user wants to attach a file to an electronic mail in a mobile phone, the user usually goes through the following operations. For example, a user goes thorough operations of opening a menu, selecting “attaching file” (selecting an icon to attach a file is also applicable) in the menu and selecting the file. However, if a file to be attached is located at a low level of the file structure, a user has to go through complicated operations to be able to actually select the file.

As a means to simplify the above complicated operations, a terminal with an electronic mail creating function to which the following technique is applied is available. An abbreviated number is associated with each file such as an image and a music file. When an abbreviated number is inputted, a file corresponding to the inputted abbreviated number is attached to the electronic mail (see Patent Literature 1).

The terminal with an electronic mail creating function has an operation unit (e.g. numerical keypad, etc.) operated by a user, a display unit (e.g. liquid crystal panel, etc.) on which a standby screen showing that the terminal is in a standby status of a user operation is displayed, a control unit that controls the display unit, and a file storage unit that stores therein various types of data such as an image file and a music file.

A different abbreviated number is allocated to each file stored in the file storage unit. When a user inputs an abbreviated number with the use of the operation unit while the standby screen is displayed on the display unit, a file to which the abbreviated number is allocated can be selected from among a plurality of data pieces stored in the file storage unit, and can be attached to the electronic mail.

That is to say, a user can identify a file by key input of an abbreviated number, and can attach the file to an electronic mail.

### [Cited Document List]

### [Patent Literature]

[Patent Literature 1] Japanese Patent Application Publication No. 2002-373137

### SUMMARY OF INVENTION

### Technical Problem

According to the terminal with an electronic mail creating function described in Patent Literature 1, as the files stored in the file storage unit increases in number, the digit number of each of the abbreviated numbers also increases. This makes it bothersome for a user to input keys of the abbreviated number, which may lower the operability for a user.

It is an object of the present invention to enhance the operability from file identification to file transmission.

### Solution to Problem

To solve the above problem, a communication terminal device pertaining to the present invention has one or more touch panels, a display processing unit operable to display information on at least one of the touch panels, a file identification unit operable to identify a target file according to information displayed within a user specification range in one of the touch panels, the user specification range being specified by a user operation of the one of the touch panels, and a file transmission unit operable to transmit the target file identified by the file identification unit to an external device.

### Advantageous Effects of Invention

With the above features, the operability from file identification to file transmission can be enhanced.

### BRIEF DESCRIPTION OF DRAWINGS

FIG. 1 is an overall perspective view of a mobile phone in accordance with Embodiment 1.

FIG. 2 is a block diagram of the mobile phone in accordance with Embodiment 1.

FIG. 3 is an illustration of an operation for specifying a range on the first touch panel in the mobile phone in accordance with Embodiment 1.

FIG. 4 is an illustration of a logical coordinate system of the mobile phone in accordance with Embodiment 1.

FIG. 5 is a flow chart showing the operation of the mobile, phone in accordance with Embodiment 1.

FIG. 6 is a front overview of the mobile phone in accordance with Embodiment 1.

FIG. 7 shows a state of the mobile phone in accordance with Embodiment 1 after a user has specified a range.

FIGS. 8A and 8B are each a conceptual view of files stored in the storage unit of the mobile phone in accordance with Embodiment 1.

FIG. 9 shows a state where the content of a file is displayed on the second touch panel of the mobile phone in accordance with Embodiment 1.

FIG. 10 shows an operation to attach a file whose content is displayed on the second touch panel in the mobile phone in accordance with Embodiment 1.

FIG. 11 shows a state of the mobile phone in accordance with Embodiment 1 after a user has inputted data with the second touch panel.

FIG. 12 shows a state of the mobile phone in accordance with Embodiment 1 after the file has been attached to an electronic mail.

FIG. 13 is an overview of file management information used by the mobile phone in accordance with Embodiment 1.

FIG. 14 is a flow chart showing the operation performed in file search processing in the mobile phone in accordance with Embodiment 1.

FIG. 15 is a conceptual view to illustrate the operation performed in the file search processing in the mobile phone in accordance with Embodiment 1.

FIG. 16 is a configuration diagram of a communication system in accordance with Embodiment 2.

FIG. 17 is an overview of file management information used in the communication system in accordance with Embodiment 2.

FIG. 18 is a flow chart showing the operation of the communication system in accordance with Embodiment 2.

FIG. 19 is a conceptual view to illustrate the operation performed in the file search processing in the communication system in accordance with Embodiment 2.

FIGS. 20A and 20B are each an illustration of an operation for specifying a range on the first touch panel in a mobile phone in accordance with a modification of Embodiment 1.

FIGS. 21A and B are each an illustration of an operation for specifying a range on the first touch panel in the mobile phone in accordance with the modification of Embodiment 1.

FIG. 22 is a flow chart showing the operation of the mobile phone in accordance with the modification of Embodiment 1.

FIG. 23 shows a state of the mobile phone in accordance the modification of Embodiment 1 after a user has specified a range.

FIG. 24 is an illustration of an operation for starting the file search processing in the mobile phone in accordance with the modification of Embodiment 1.

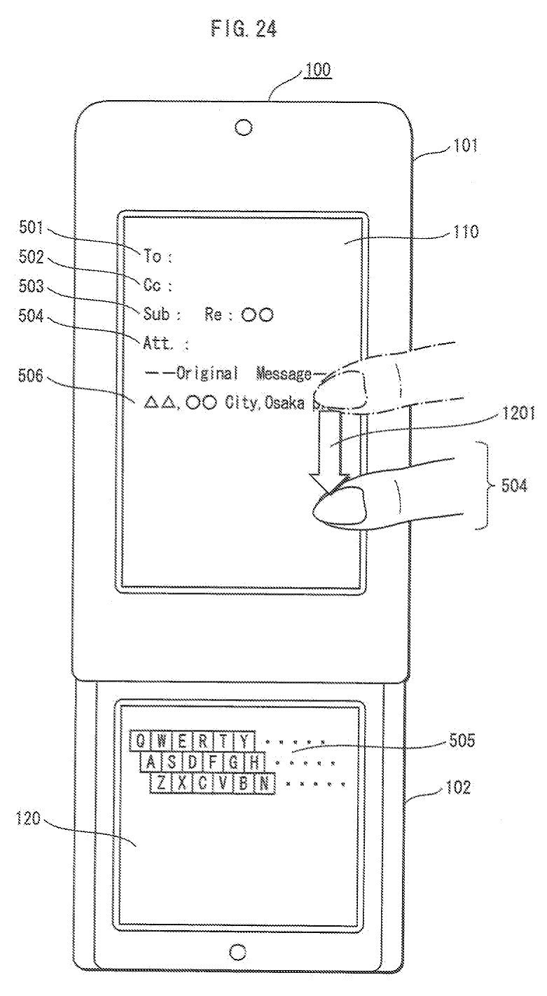

FIG. 25 is an illustration of an operation for starting the file search processing in the mobile phone in accordance with the modification of Embodiment 1.

FIG. 26 is an illustration of an operation for attaching a file to an electronic mail in the mobile phone in accordance with the modification of Embodiment 1.

### DESCRIPTION OF EMBODIMENTS

### Embodiment 1

The following describes an embodiment of a mobile phone 100 that is a communication terminal device pertaining to the present invention.

<1> Overview

The mobile phone 100 pertaining to this embodiment is provided with a touch panel. According to the mobile phone, a file is identified among a plurality of files each having a unique file name according to information (hereinafter, referred to as “user specification range information”) included in a range specified by a user operation of the touch panel (hereinafter, referred to as “user specification range”), and the identified file is attached to an electronic mail and transmitted.

<2> Configuration

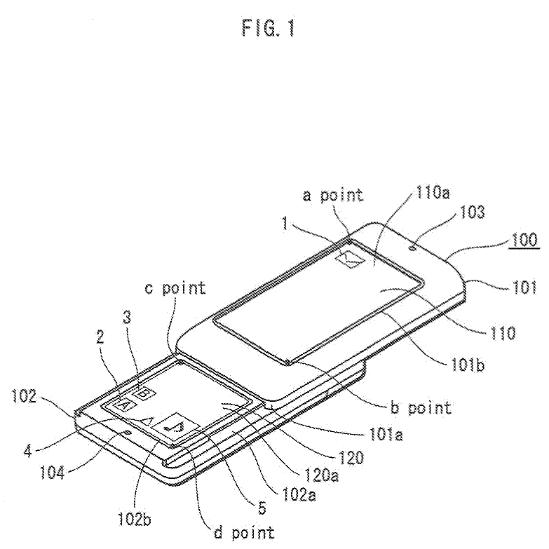

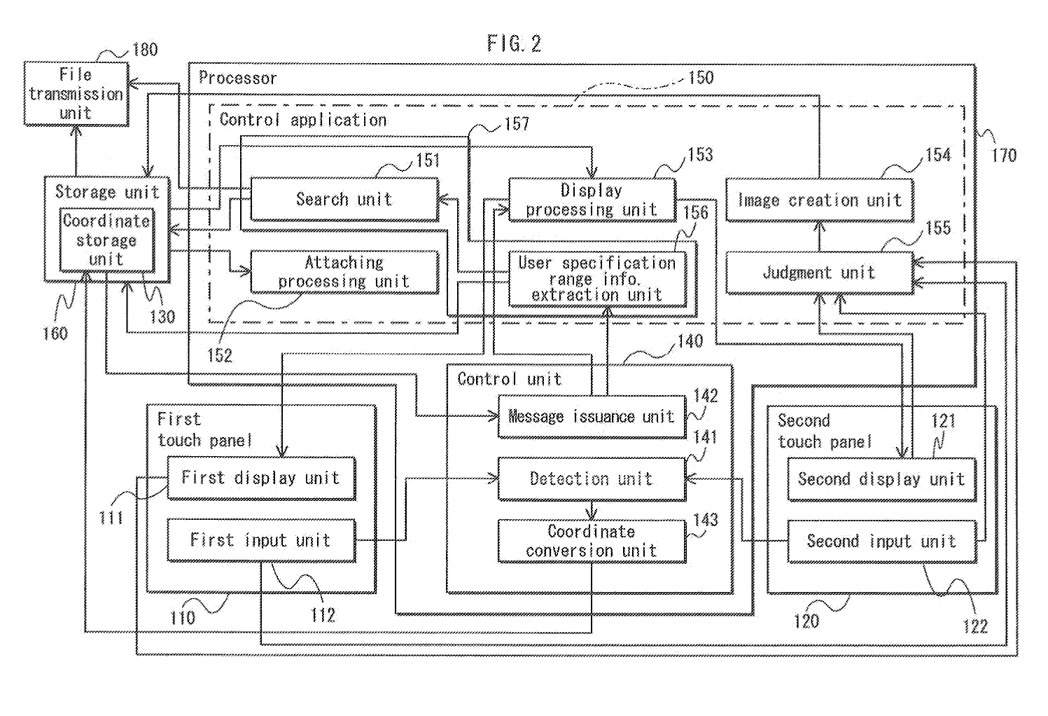

FIG. 1 shows the mobile phone 100 which is a communication terminal device pertaining to the embodiment. FIG. 2 is a block diagram of the mobile phone 100.

The mobile phone 100 pertaining to the embodiment includes a first touch panel 110, a second touch panel 120, a processor 170, a storage unit 160, and a file transmission unit 180 that transmits a file to an external device by transmitting the electronic mail to which the file has been attached.

A part of the area of the storage unit 160 constitutes a coordinate storage unit 130.

Here, the processor 170 realizes the functions of the display processing unit 153 that displays information on the first touch panel 110 and the second touch panel 120 and the file identification unit 157 that identifies a file among a plurality of files having been stored in the storage unit 160 according to the user specification range information. Note that in this embodiment, a description is given on the assumption that a file is constituted from map image data constituting a bitmap image of a map or photo image data constituting a bitmap image of a photograph.

Also, when data (hereinafter, referred to as “touch point data”) showing the coordinate values (hereinafter, referred to as “physical coordinate values”) of a position touched by the finger of the user is inputted via the first touch panel 110 and the second touch panel 120, the processor 170 realizes the following functions with the following units. A control unit 140 has a function of issuing a message, which will be described later, to a display processing unit 153 and a file identification unit 157 based on the touch point data. An attaching processing unit 152 has a function of attaching a file, which is to be externally transmitted by a file transmission unit 180, to an electronic mail. An image creation unit 154, which is a file creation unit, has a function of creating a new file based on data inputted by a user via the second touch panel 120 and data constituting the file identified by the file identification unit 157. A judgment unit 155 has a function of judging whether a predetermined time has passed since the content of the file is displayed on the second touch panel 120, and notifying the image creation unit 154 of the judgment result if the judgment result is positive. Note that the processor 170 executes a control application 150 stored in the storage unit 160, thereby realizing the functions of the display processing unit 153, a user specification range information extraction unit 156, a search unit 151, the attaching processing unit 152, the image creation unit 154, and the judgment unit 155.

The first touch panel 110 has a first display unit 111 and a first input unit 112. The second touch panel 120 has a second display unit 121 and a second input unit 122.

The first display unit 111 is constituted from a first LCD (Liquid Crystal Display) 110a and a first display control circuit (unillustrated) that display characters and images such as icons on the first LCD 110a. The second display unit 121 is constituted from a second LCD 120a and a second display control circuit (unillustrated) that displays characters and images such as icons on the second LCD 120a. Here, the first display control circuit and the second display control circuit operate based on a control signal inputted from the processor 170.

The first input unit 112 and the second input unit 122 respectively have functions of outputting touch point data to the processor 170 at regular intervals (e.g. 1/60 second) while the user has his finger touching the first touch panel 110 and the second touch panel 120. Note that a general-use resistance touch panel, an optical touch panel or a capacitive touch panel may be used as the first touch panel 110 and the second touch panel 120, and that a user interface used for these touch panels may be used as the first input unit 112 and the second input unit 122 as necessary. In this embodiment, a capacitive touch panel is used.

Here, a brief description is given of operation of the first input unit 112 and the second input unit 122.

According to the mobile phone 100 of this embodiment, it is assumed that the pixel number of the first LCD 110a is 151 pixels (long)×301 pixels (wide) and that the pixel number of the second LCD 120a is 151 pixels (long)×201 pixels (wide).

When a user puts his finger at the point a (upper left end of the first LCD of the first touch panel) of the first touch panel 110 as shown in FIG. 1, the first input unit 112 outputs the touch point data of the physical coordinate values (0, 0). When a user puts his finger at the point b (lower right end of the first LCD of the first touch panel) of the first touch panel 110 as shown in FIG. 1, the first input unit 112 outputs the touch point data of the physical coordinate values (150, 300). When a user puts his finger at the point c (upper left end of the second LCD 120a of the second touch panel 120) of the second touch panel 120 as shown in FIG. 1, the second input unit 122 outputs touch point data of the physical coordinate values (0, 0). When a user puts his finger at the point d (lower right end of the second LCD 120a of the second touch panel 120) of the second touch panel 120 as shown in FIG. 1, the second input unit 122 outputs touch point data of the physical coordinate values (150, 200).

The display processing unit 153 has functions of displaying information on the first touch panel 110 and displaying a content of a file identified by the file identification unit 157 on the second touch panel 120. Here, when a file is constituted from map image data, the display processing unit 153 displays a bitmap image of a map on the second touch panel 120.

The file identification unit 157 is constituted from the user specification range information extraction unit 156 and the search unit 151. The file identification unit 157 extracts the user specification range information from information displayed on the first touch panel 110. The search unit 151 searches a plurality of files stored in the storage unit 160 for a file having a file name that matches to a character string in the user specification range information.

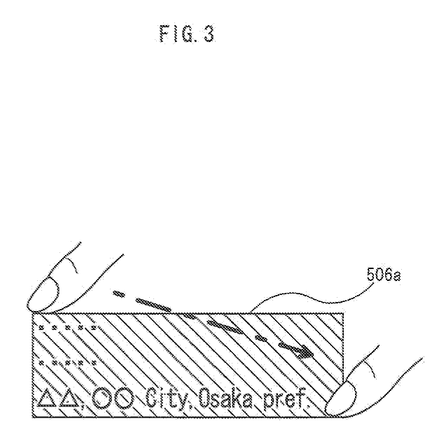

Here, as shown in FIG. 3, a user can specify a range by putting his finger, a stylus pen or the like (pointing means) on the first touch panel 110, then sliding his finger along the first touch panel 110 with his finger touching the first touch panel 110, and moving his finger away from the first touch panel 110. That is to say, as shown in FIG. 3, a range 506a in the first touch panel 110 can be specified as follows. First, a user puts his finger on one vertex (first point) in a rectangular range surrounding the entire character string a user attempts to specify. With his finger touching the first touch panel 110, the user slides the finger to another vertex (second point) that is opposed to the one vertex via the center of the range.

The user specification range information extraction unit 156 has a function of storing the extracted user specification range information in the storage unit 160.

The search unit 151 extracts a character string (hereinafter, referred to as “file name candidate character string”) that is a candidate of a file name by parsing character string in the user specification range information, which will be described later. The search unit 151 acquires file management information, which will be described later, relevant to a plurality of files stored in the storage unit 160, and subsequently searches the plurality of files for a file name matching the file name candidate character string based on the file management information. When the file name is detected, the search unit 151 identifies a file having the file name among the plurality of files (the details of the operation of the search unit 151 will be described in <3-2>).

In order for the file transmission unit 180 to externally transmit an electronic mail, to which a file identified by the file identification unit 157 has been attached, the attaching processing unit 152 has a function of attaching the file to the electronic mail.

The image creation unit 154 activates a drawing application stored in the storage unit 160 and enables a user to perform drawing with his finger on the second touch panel 120. Here, the image creation unit 154 has a function of creating a new file as follows. When a user draws a path by dragging his finger on the second touch panel 120, the image creation unit 154 acquires the physical coordinate values existing on the path, and changes the color of pixels on the path based on the physical coordinate values on the bitmap image displayed on the second touch panel 120.

The control unit 140 has a detection unit 141, a message issuance unit 142 and a coordinate conversion unit 143. The detection unit 141 detects the operation status of each of the first touch panel 110 and the second touch panel 120 based on data showing the physical coordinate values inputted to the processor 170 via the first touch panel 110 and the second touch panel 120. The message issuance unit 142 issues, to the user specification range information extraction unit 156, a message (PRESS message) showing the first touch panel 110 and the second touch panel 120 are each in a touch status, or a message (MOVE message) showing the touch position of the forger of the user after the user has moved his finger with his finger touching the first touch panel 110 or the second touch panel 120. When data showing physical coordinate values is inputted in the processor 170 via the first touch panel 110 and the second touch panel 120, the coordinate conversion unit 143 converts the physical coordinate values in the data to the coordinate values (hereinafter, referred to as logical coordinate values) in the operation control coordinate system, which will be described later, and outputs the converted coordinate values.

Here, a PRESS message contains the physical coordinate values of the touch point at which the user puts his finger and touch panel identification information for identifying to which of the first touch panel 110 and the second touch panel 120 the touch point belongs. A MOVE message contains the physical coordinate values of the moved touch position and touch panel identification information for identifying to which of the first touch panel 110 and the second touch panel 120 the touch position belongs. Note that the processor 170 executes a control program stored in the storage unit 160, thereby realizing each of the functions of the detection unit 141, the message issuance unit 142 and the coordinate conversion unit 143 that partially constitute the control unit 140.

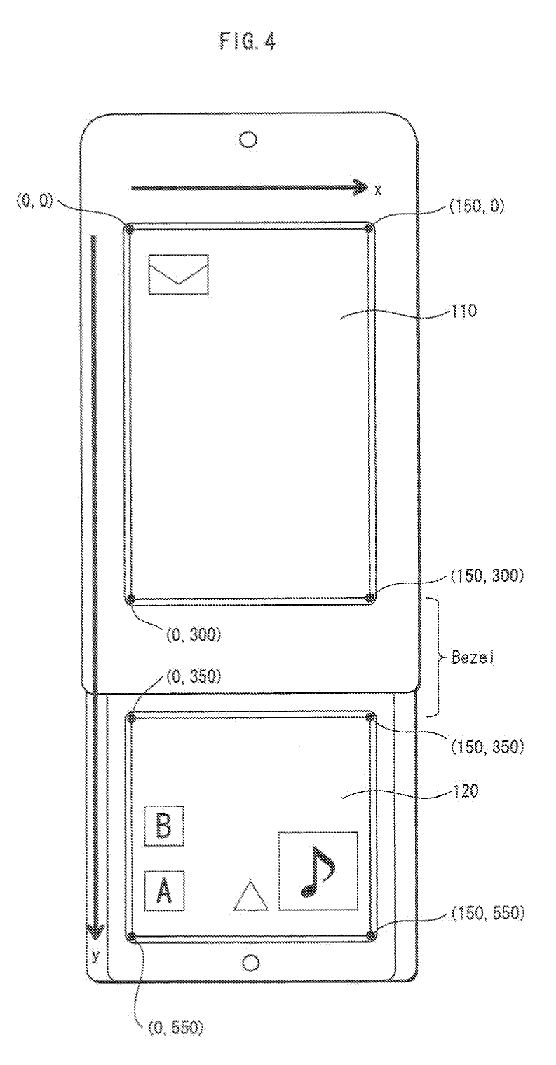

Here, a description is given of the above-mentioned operation control coordinate system based on FIG. 4. Hereinafter, a description is given on the assumption that the longitudinal direction of the mobile phone 100 shown in FIG. 4 is the vertical direction, and that the lateral direction of the mobile phone 100 is the horizontal direction.

In the operation control coordinate system, the coordinate values of the upper left corner of the first touch panel 110 are assumed to be (0, 0), the horizontal direction is assumed to be the x axis, the vertical direction is assumed to be the y axis, and the rightward direction of the x axis is assumed to be the forward direction, and the downward direction of the y axis is assumed to be the forward direction. In the description of this embodiment, each coordinate value in the operation control coordinate system is referred to as a logical coordinate value. FIG. 4 shows an example of the operation control coordinate system. The logical coordinate values of the upper right end of the first touch panel 110 are set as (150, 0), those of the lower left end of the first touch panel 110 as (0, 300), those of upper left end of the second touch panel 120 as (0, 350), those of the upper right end of the second touch panel 120 as (150, 350), those of the lower left end of the second touch panel 120 as (0, 550) and those of the lower right end of the second touch panel 120 as (150, 550).

Here, the value of the y coordinate in the logical coordinate values of each point along the upper end of the second touch panel 120 is set in view of the width of the bezel located between the lower end of the first touch panel 110 and the upper end of the second touch panel 120 in the vertical direction.

The first input unit 112 transmits data showing the physical coordinate values (0, 0) to the processor 170 when the user puts his finger at the upper left end of the first LCD 110a contained in the first touch panel 110, and transmits data showing the physical coordinate values (150, 300) to the processor 170 when a user puts his finger at the lower right end of the first LCD 110a. Also, the second input unit 122 transmits the physical coordinate values (0, 0) to the processor 170 when a user puts his finger at the upper left end of the second LCD 120a, and transmits the physical coordinate values (150,200) to the processor 170 when a user puts his finger at the lower right end of the second LCD 120a.

Here, the physical coordinate values inputted via the first input unit 112 of the first touch panel 110 match the logical coordinate values. With regard to the physical coordinate values inputted via the second input unit 122 of the second touch panel 120, the y coordinate of the physical coordinate values is smaller than that of the logical coordinate values by a total of the coordinate corresponding to the length of the first touch panel 110 in the vertical direction and the coordinate corresponding to the width of the bezel in the vertical direction.

Accordingly, the coordinate conversion unit 143 stores, in the coordinate storage unit 130, the physical coordinate values inputted via the first input unit 112 of the first touch panel 110 as the logical coordinate values without changing the values. The physical coordinate values inputted via the second input unit 122 of the second touch panel 120 is added by “350,” which is the total of the coordinate corresponding to the length of the first touch panel 110 in the vertical direction and the coordinate corresponding to the width of the bezel in the vertical direction, and the coordinate conversion unit 143 stores them as the logical coordinate values in the coordinate storage unit 130.

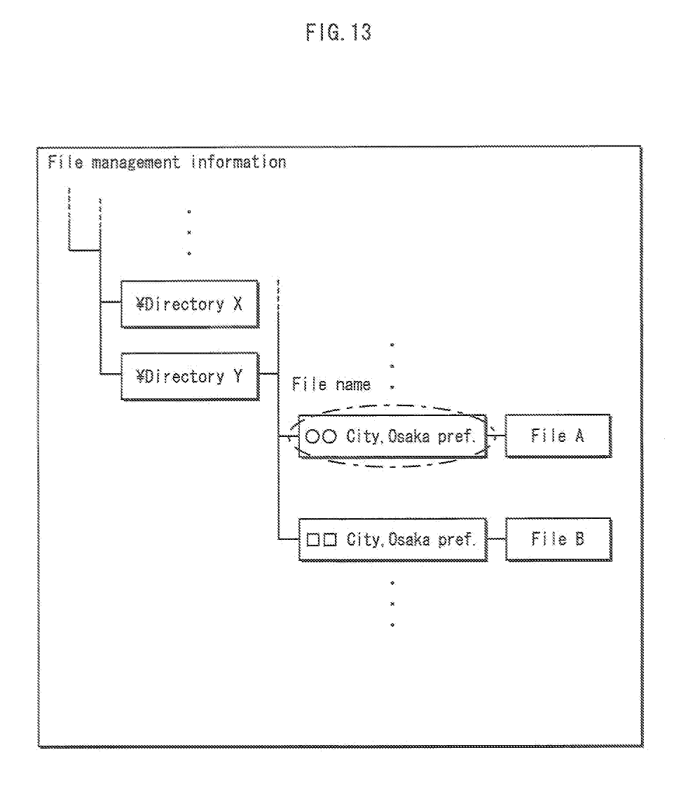

The storage unit 160 stores therein the display control application, various types of programs such as the control program, and a plurality of files (e.g. image file, etc.). One area contained in the storage unit 160 constitutes a coordinate storage unit 130 for storing therein data showing the logical coordinate values outputted from the coordinate conversion unit 143. Furthermore, another area contained in the storage unit 160 constitutes a temporary storage unit for temporarily storing therein user specification range information extracted by the user specification range information extraction unit 156. Note that the storage unit 160 can be constituted from various types of memories such as SRAM (Static Random Access Memory). Also, the plurality of files have been stored in the storage unit 160 in response to a user operation of the first touch panel 110 or the second touch panel 120. Also, the storage unit 160 stores therein file management information as shown in FIG. 13. Here, as shown in FIG. 13, the file management information is constituted from information showing that a file A having a file name “∘∘ city, Osaka Pref.” is located in the directory Y, or the like.

The attaching processing unit 152 attaches a file identified by the file identification unit 157 to an electronic mail, and the file transmission unit 180 externally transmits the electronic mail to which the file has been attached.

As shown in FIG. 1, the mobile phone 100 pertaining to the embodiment has a rectangular-plate-like first package 101 and a rectangular-plate-like second package 102 being slidably, in the longitudinal direction of the first package 101, attached to one surface, in the thickness direction, of the first package 101. On the one surface of the first package 101, engaging protrusions 101a are formed in the longitudinal direction at the both ends, in the lateral direction, of the first package 101. On the other hand, on one surface of the second package 102 toward the first package 101 in the thickness direction of the second package 102, engaged groove parts 102a are formed in the longitudinal direction at the both ends, in the lateral direction, of the second package 102. Here, the second package 102 is fixed to the one surface of the first package 101 with the engaged grooved parts 102 being engaged with the engaging protrusion 101a of the first package 101.

The first package 101 has a first window part 101b, in a rectangular shape in a planar view, formed on another surface opposite to the one surface in the thickness direction, and the first touch panel 110 is provided within the first window part 101b. Also, a speaker 103 is provided at one end of the other surface of the first package 101 in the longitudinal direction of the first window part 101b.

The second package 102 has a second window part 102b, in a rectangular shape in a planar view, on one surface facing the first package 101 in the thickness direction. The second touch panel 120 is provided within the second window part 102b. Also, on the one surface of the second package 102 facing the first package 101, a microphone 104 is provided at another end opposite, in the longitudinal direction of the second window part 102b, to the one end.

Accordingly, when a user slides the second package 102 relative to the first package 101 in the longitudinal direction of the first package 101, the second touch panel 120 of the second package 102 is exposed, so that the user is able to put his finger, a stylus pen or the like, on the second touch panel 120 and also able to input sound via the microphone 104.

An image representing a group of keys such as cursor keys and QWERTY keys or an image representing an icon (see FIG. 1) are displayed on the first touch panel 110 and the second touch panel 120. A user can operate the mobile phone 100 by putting his finger on the image representing the key group and the image representing the icon.

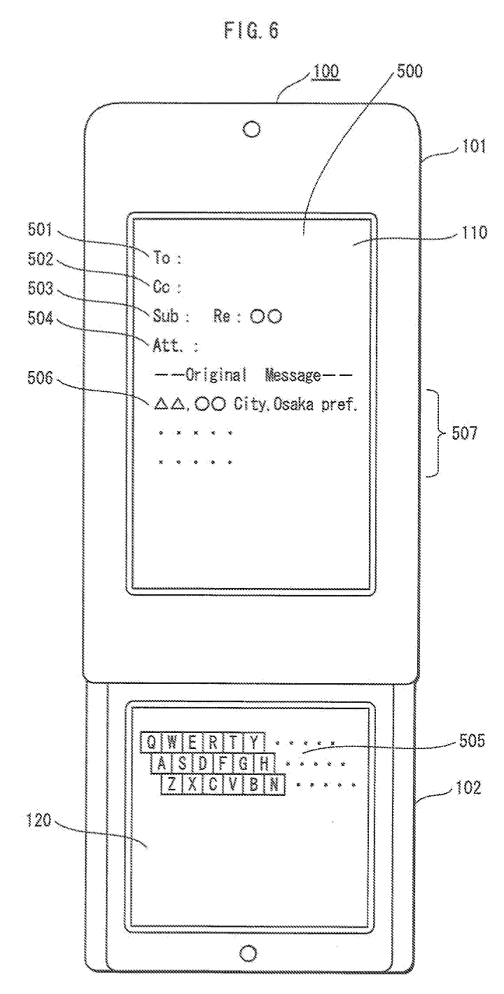

As shown in FIG. 6, when a plurality of QWERTY keys are displayed on the first touch panel 110, a user can input character data, etc. to the mobile phone 100 merely by putting his fingers on the QWERTY keys. Also, as shown in FIG. 1, when first to fifth icons 1-5 are displayed on the first touch panel 110 and the second touch panel 120, a user can play back a music file in the mobile phone 100 by putting his finger on the fifth icon 5. Alternatively, when an image (unillustrated) showing a cursor key is displayed on the first touch panel 110, a user can move the cursor key within the first touch panel 110 by putting his finger at the position shown by the cursor key and sliding with the finger on the first touch panel.

<3> Operation

<3-1> Description of Entire Operation

Next, a description is given of the operation of the mobile phone 100 pertaining to the embodiment.

Hereinafter, a description is given on the following assumption. The operation statuses of the first touch panel 110 and the second touch panel 120 include a touch status where a user keeps his finger touching the first touch panel 110 or the second touch panel 120, a detach status where a user has his finger detached from the first touch panel 110 or the second touch panel 120, and a drag status where the operation status of the first touch panel 110 or the second touch panel 120 is maintained in the touch status. In general, a drag status means a status where a user moves his finger along the first touch panel 110 or the second touch panel 120 while keeping his finger touching the first touch panel 110 or the second touch panel 120. However, in this embodiment, note that a drag status includes a case where a user keeps his finger on part of the first touch panel 110 or the second touch panel 120 and does not move the position of his finger.

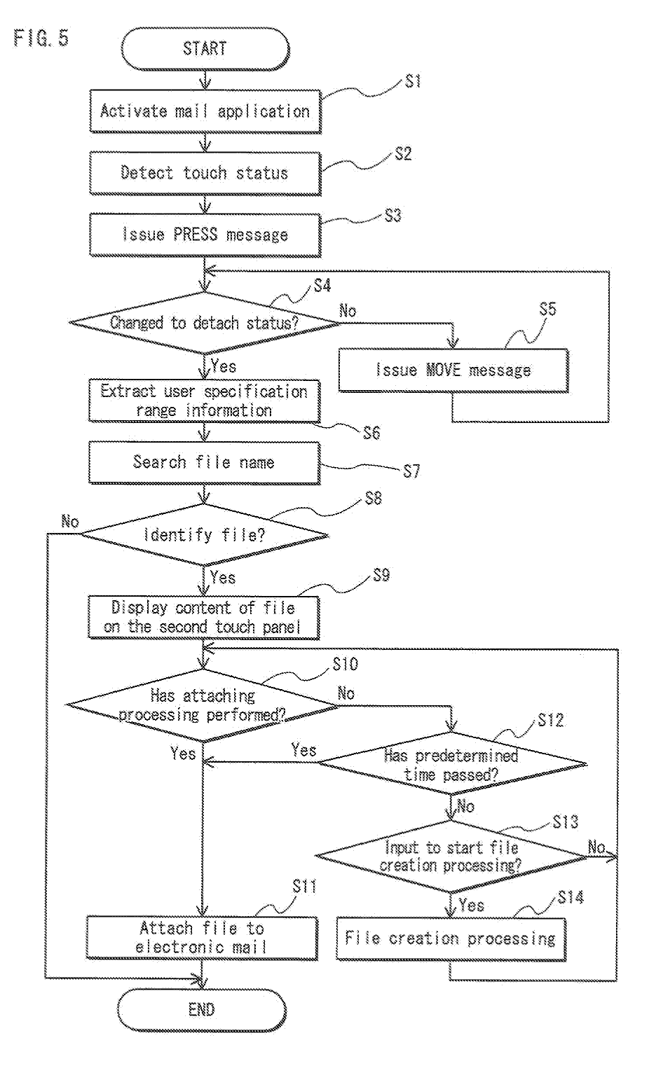

FIG. 5 is a flow chart showing an operation of the mobile phone 100 pertaining to the embodiment.

With the use of FIG. 5, a description is given of the operation, by way of example, where a reply mail application is activated and where one file selected from among a plurality of files having been stored in the storage unit 160 is attached to the reply mail (electronic mail).

First, when a user activates a reply mail application, a list of subjects of a plurality of electronic mails received at the mobile phone 100 is displayed on the first touch panel 110.

Next, when the user puts his finger at a portion of the list of the subjects where a subject of the electronic mail to which a reply mail is attempted to be made is displayed, as shown in FIG. 6, a reply mail creation screen for creating the reply mail is displayed on the first touch panel 110 (Step S1).

Here, a reply mail creation screen 500 is displayed on the first touch panel 110, and QWERTY keys 505 are displayed on the second touch panel 120. Here, the reply mail creation screen 500 is constituted from an address display area 501, a CC display area 502, a subject display area 503, an attached file display area 504 and a text display area 506 for displaying therein a text 507 made of a content of the electronic mail to which the reply mail is attempted to be made.

Next, when a user puts his finger at a position on the first touch panel 110 or the second touch panel 120, the touch point data, which shows the physical coordinate values of the position, is inputted to the processor 170. The detection unit 141 detects that the first touch panel 110 or the operation status of the second touch panel 120 is in the touch status (Step S2).

When the detection unit 141 detects that the first touch panel 110 or the second touch panel 120 is in the touch status, the message issuance unit 142 intermittently issues PRESS messages to the display processing unit 153 at regular intervals (e.g., 1/60 second) (Step S3).

In Step S3, when receiving a PRESS message, the display processing unit 153 performs display on the first touch panel 110 or the second touch panel 120 to show that characters displayed at the touch position are specified by the user. For example, the display processing unit 153 performs such display by changing both the colors of the character and its background displayed at the touch position in the first touch panel 110 or the second touch panel 120.

Here, the display processing unit 153 controls the first display unit 111 of the first touch panel 110 and the second display unit 121 of the second touch panel 120 based on the physical coordinate values contained in the PRESS message and the touch panel identification information, thereby changing the display content of the first touch panel 110 or the second touch panel 120.

In Step S3, the coordinate conversion unit 143 acquires the touch point data inputted in the processor 170 via the first touch panel 110 or the second touch panel 120, converts the physical coordinate values contained in the touch point data to the logical coordinate values, and outputs data showing the logical coordinate values.

Next, the detection unit 141 performs judging processing to judge whether the first touch panel 110 or the second touch panel 120 in the touch status is changed to be in the detach status (Step S4). The judging processing is performed based on whether the touch point data has been inputted in the processor 170 via the first touch panel 110 or the second touch panel 120. That is to say, when detecting that the touch point data has been inputted in the processor 170 via the first touch panel 110 or the second touch panel 120 in the touch status, the detection unit 141 judges that the first touch panel 110 or the second touch panel 120 are maintained in the touch status. When detecting that the touch point data is no longer inputted in the processor 170 via the first touch panel 110 or the second touch panel 120 in the touch status, the detection unit 141 judges that the first touch panel 110 or the second touch panel 120 is changed to be in the detach status.

In Step S4, when the detection unit detects that the first touch panel 110 or the second touch panel 120 is maintained in the touch status (Step S4: No), the message issuance unit 142 intermittently issues MOVE messages to the display processing unit 150 at regular intervals (e.g.; 1/60 second) to the display processing unit 150 (Step S5).

In Step S5, the coordinate conversion unit 143 acquires the moved touch point data, which is to be inputted in the processor 170, via the first touch panel 110 or the second touch panel 120, converts the physical coordinate values contained in the moved touch point data to the logical coordinate values, and outputs data showing the logical coordinate values. After this, until it is judged that the first touch panel 110 or the second touch panel 120 in the touch status is changed to be in the detach status, (Step S4: Yes), the judging processing of the operation status of each of the first touch panel 110 and the second touch panel 120 (Step S4) and issuance of MOVE messages from the message issuance unit 142 to the display processing unit 153 (Step S5) are repeated.

Here, the display processing unit 153 performs display on the first touch panel 110 or the second touch panel 120 so as to indicate that characters displayed in the user specification range 506a defined as follows are specified by the user. The user specification range 506a is defined by a rectangular range including a line connecting a position (first point) specified by the physical coordinate values in a PRESS message and touch panel identification information and a position (second point) specified by the physical coordinate values included in a MOVE message and touch panel identification information.

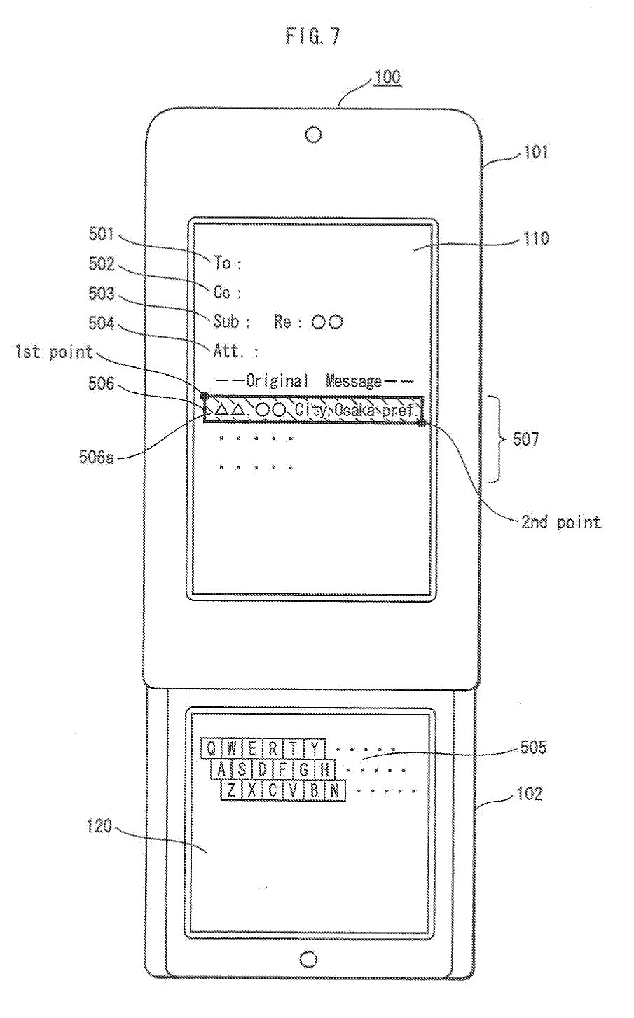

On the other hand, when it is judged that the first touch panel 110 or the second touch panel 120 in the touch status is changed to be in the detach status in Step S4 (Step S4: Yes), the message issuance unit 142 issues a MOVE message to the user specification range information extraction unit 156 that partially constitutes the display processing unit 150 and the file identification unit 157. The user specification range information extraction unit 156 extracts information (hereinafter, referred to as user specification range information) contained in the user specification range 506a on the assumption that a rectangular range (see FIG. 7), which includes the line connecting the position (first point) specified by the physical coordinate values included in the PRESS message and the touch panel identification information and the position (second point) specified by the physical coordinate values included in the MOVE message and the touch panel identification information, is the user specification range 506a, and stores the user specification range information in a temporary storage unit (unillustrated) included in the storage unit 160 (Step S6). Note that the operation for extracting user specification range information by the user specification range information extraction unit 156 will be described in <3-2>.

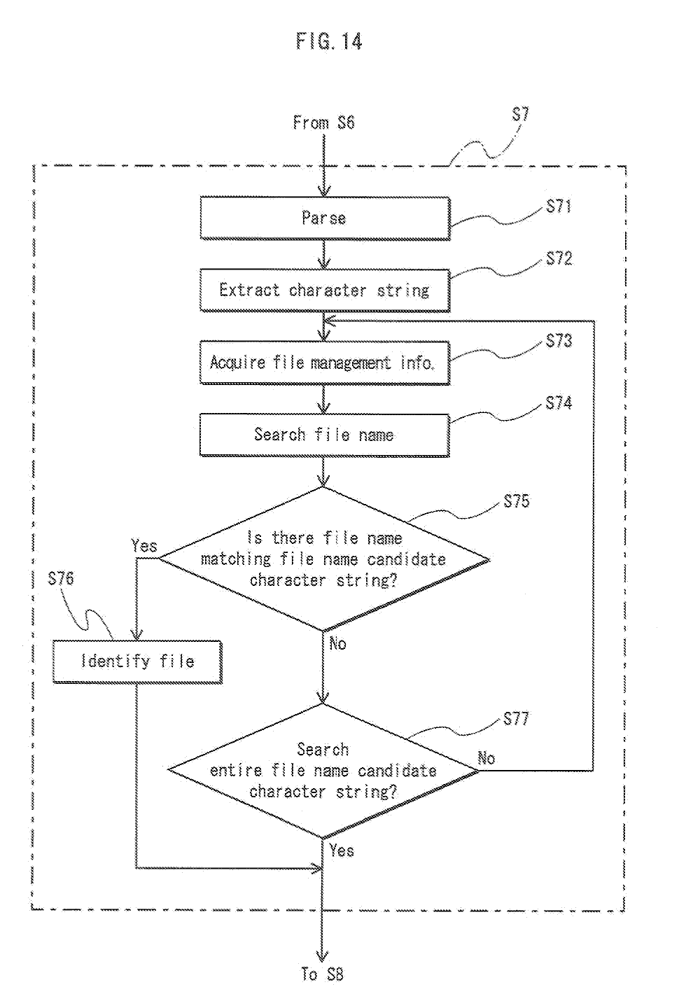

Next, the search unit 151 that partially constitutes the file identification unit 157 searches the plurality of files having been stored in the storage unit 160 for a file having a file name matching a character string in the user specification range information (Step S7). The details of the file searching processing are described with the use of FIG. 14.

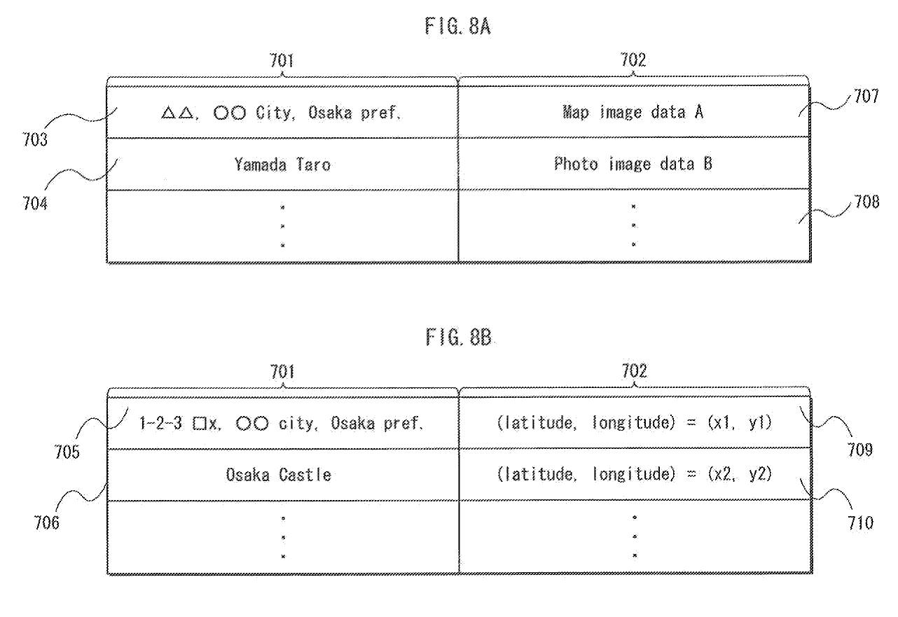

Here, the details of the operation in Step S7 are described with the use of the conceptual view of the files stored in the storage unit 160 (see FIGS. 8A and 8B). As shown in FIG. 8A, the storage unit 160 stores therein a plurality of files, such as a file constituted from map image data (map image data A) showing a map around a predetermined area (ΔΔ, ∘∘ city, Osaka Pref.) and having a file name 703 which is the name of the predetermined area, and a file constituted from photo image data (photo image data B) of a certain person and having a file name 704 which is the name of the person (Yamada Taro).

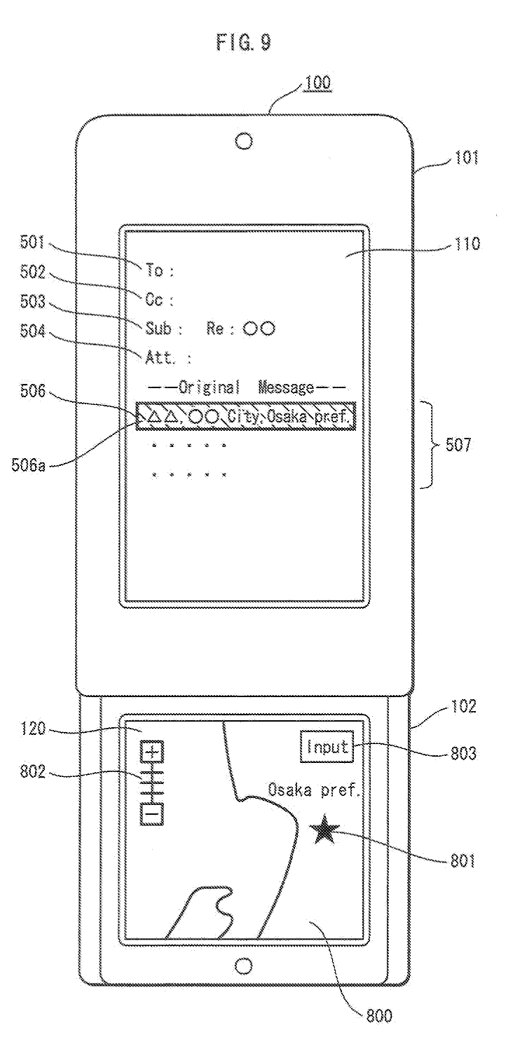

Here, FIG. 9 shows the external appearance of the mobile phone 100 in a state where a map image is displayed on the second touch panel 120. As shown in FIG. 9, the content of the map image file (map image) is displayed on the second touch panel 120. As is apparent from the comparison between FIG. 6 and FIG. 9, the map image is displayed on the second touch panel 120 instead of the QWERTY key 505. Also, as shown in FIG. 9, on the map image displayed on the second touch panel 120, a mark 801 showing a main location, a scaling part 802 used for increasing and reducing the scale, an input start button 803 for making a status to enable a user to input data on the second touch panel 120. The input start button 803 is operated when a user inputs data via the second touch panel 120, which will be described later.

Next, as a result of Step S7, the search unit 151 judges whether a file having a file name containing a character string in the user specification range information is identified (Step S8).

In Step S8, when judging that the file name containing the character string in the user specification range information is not identified (Step S8: No), the search unit 151 terminates the operation for attaching a file stored in the storage unit 160 to a reply mail.

On the other hand, in Step S8, when the search unit 151 judges that the file having the file name containing the character string in the user specification range information has been identified (Step S8: Yes), the following processing is performed according to a type of the file stored in the storage unit 160. In a case where the storage unit 160 stores therein a plurality of files constituted from map image data or the like as shown in FIG. 8A, when the search unit 151 identifies a file having the file name 703 which is the name of the predetermined area (ΔΔ, ∘∘ city, Osaka Pref.), the display processing unit 153 displays the map image data (map image data A) showing a map around the predetermined area, which is the content of the file, on the second touch panel 120 (Step S9).

Here, the map image data is, for example, constituted from data compressed in a compression format such as JPEG. After decompressing data identified by the search unit 151 as necessary, the display processing unit 153 displays the map image data on the second touch panel 120- (Step S9).

Next, the attaching processing unit 152 judges whether the user has performed attaching operation for attaching the file identified by the search unit 151 to an electronic mail via the second touch panel 120 (Step S10).

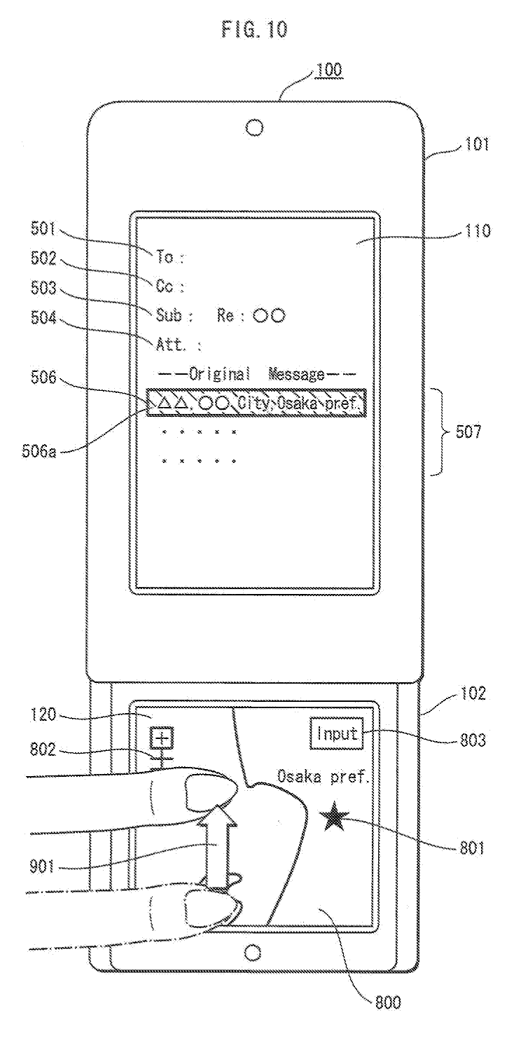

The attaching operation is performed as follows as shown in FIG. 10. A user puts his finger on the second touch panel 120, and slides it for a predetermined distance in a direction (upward direction) toward the first touch panel 110 with his finger on the second touch panel 120.

When it is judged that the user has performed the attaching operation in Step S10 (Step S10: Yes), the attaching processing unit 152 attaches the file identified by the file identification unit 157 to an electronic mail (Step S11).

On the other hand, when it is judged that the user has not performed the attaching operation in Step S10 (Step S10: No), the judgment unit 155 judges whether a predetermined time (e.g. 5 seconds) has passed since start of the display of the map image on the second touch panel 120 (Step S12).

Note that, the predetermine time is not limited to 5 seconds, and that other appropriate time may be set for the predetermined time.

When the judgment unit 155 judges that a predetermined time has passed since the start of the display of the map image on the second touch panel 120 in Step S12 (Step S12:Yes), the file identified by the file identification unit 157 is attached to the electronic mail (Step S10).

On the other hand, when the judgment unit 155 judges that a predetermined time has not passed since the start of the display of the map image on the second touch panel 120 in Step S12 (Step S12: No), the image creation unit 154 judges whether the user has put his finger on the input start button 803 displayed in the second touch panel 120 shown in FIG. 9 (Step S13).

When it is judged that the user has not put his finger, a stylus pen or the like on the input start button 803 in Step S13 (Step S13: No), the attaching processing unit 152 judges again whether the file identified by the file identification unit 157 has been attached to an electronic mail (Step S10).

On the other hand, when it is judged that the user has put his finger, a stylus pen or the like on the input start button 803 in Step S13 (Step S13: Yes), the image creation unit 154 activates a drawing application stored in the storage unit 160 (Step S14).

When the image creation unit 154 activates the drawing application, the user is able to perform drawing of the map image displayed on the second touch panel 120 with a stylus pen or the like. Here, a paint tool application may be used as the drawing application.

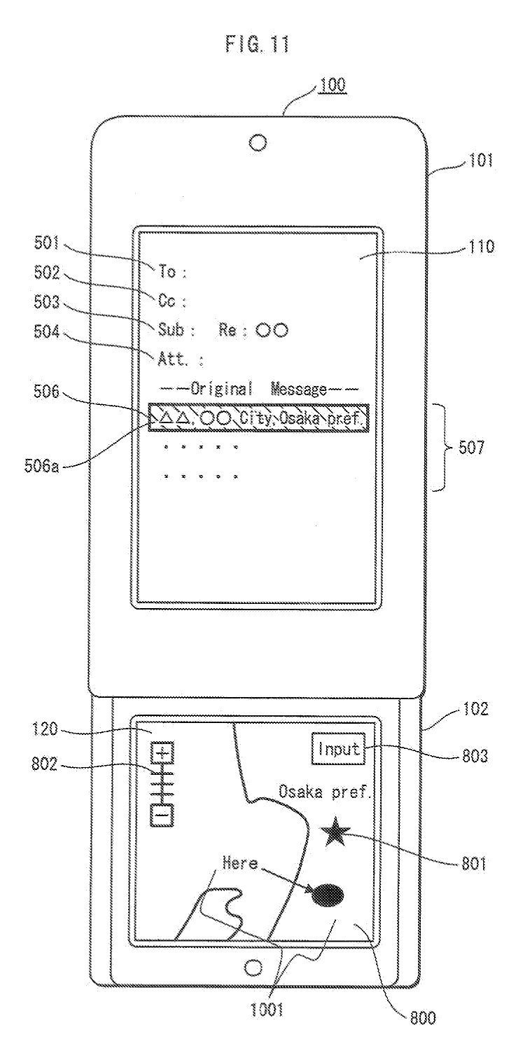

Next, when data (e.g. image data 1001 shown in FIG. 11) is inputted via the second touch panel 120 (e.g., drawing is performed on the second touch panel 120 with a finger or the like), the image creation unit 154 performs file creation processing for creating a new file based on data constituting the file identified by the search unit 151 and data inputted by the user (Step S14).

Next, the attaching processing unit 152 judges whether the user has performed attaching operation for attaching the file to an electronic mail via the second touch panel 120 (Step S10).

Here, when the attaching processing unit 152 judges that data has been attached to the electronic mail (Step S10: Yes), a new file created by the file creation processing is attached to an electronic mail (Step S11).

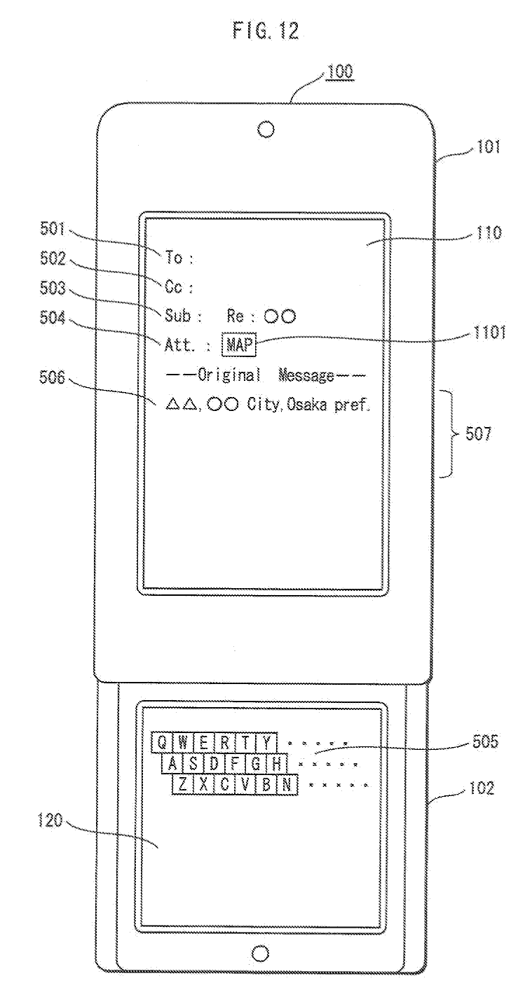

Here, FIG. 12 shows an external appearance of the mobile phone 100 after a file has been attached to an electronic mail. As shown in FIG. 12, an icon 1101 showing the file is displayed on the attached file display area 504 of the reply mail screen 500. Also, as shown in FIG. 12, after the file has been attached, the QWERTY keys 505 are displayed again on the second touch panel 120.

<3-2> Description of Operation Performed in File Search Processing

Next, a detailed description is given of the operation in the file search processing in FIG. 5.

Here, FIG. 14 shows a flow chart showing file search processing when user specification range information is a character string constituted from a plurality of characters.

First, the search unit 151 parses the character string constituting the user specification range information extracted by the user specification range information extraction unit 156, and identifies boundary positions in the construction of the character string (Step S71). Here, the parsing is performed with the use of Lexical functional grammar, for example.

Next, the search unit 151 extracts a character string composing a potential noun used as a file name (hereinafter, referred to as file name candidate character string) based on the boundary positions of the construction of the character string (Step S72).

Next, the search unit 151 acquires file management information with regard to the plurality of files stored in the storage unit 160 (Step S73). As shown in FIG. 14, the file management information includes file names unique to the respective files stored in the storage unit 160 and information with regard to the locations of the respective files.

Next, the search unit 151 searches a file having the file name that matches a file name candidate character string based on the file management information (Step S74).

Next, the search unit 151 judges whether there is a file having the file name that matches the file name candidate character string in Step S74 (Step S75).

When the search unit 151 judges that there is a file having the file name that matches the file name candidate character string in Step S75 (Step S75:Yes), the search unit 151 identifies the file based on the file management information and the processing directly proceeds to the next Step S77 (Step S76).

On the other hand, when judging that there is no file having the file name that matches the file name candidate character string in Step S75 (Step S75: No), the processing directly proceeds to the next Step S77 (Step S76).

Next, the search unit 151 judges whether the entire file name candidate character string has been searched (Step S77).

When it is judged that the entire file name candidate character string has been searched in Step S77 (Step S77: Yes), the processing proceeds to Step 8.

On the other hand, when it is judged that not the entirety of the character string has been searched in Step S77 (Step S77: No), the processing from Step S73 is performed again.

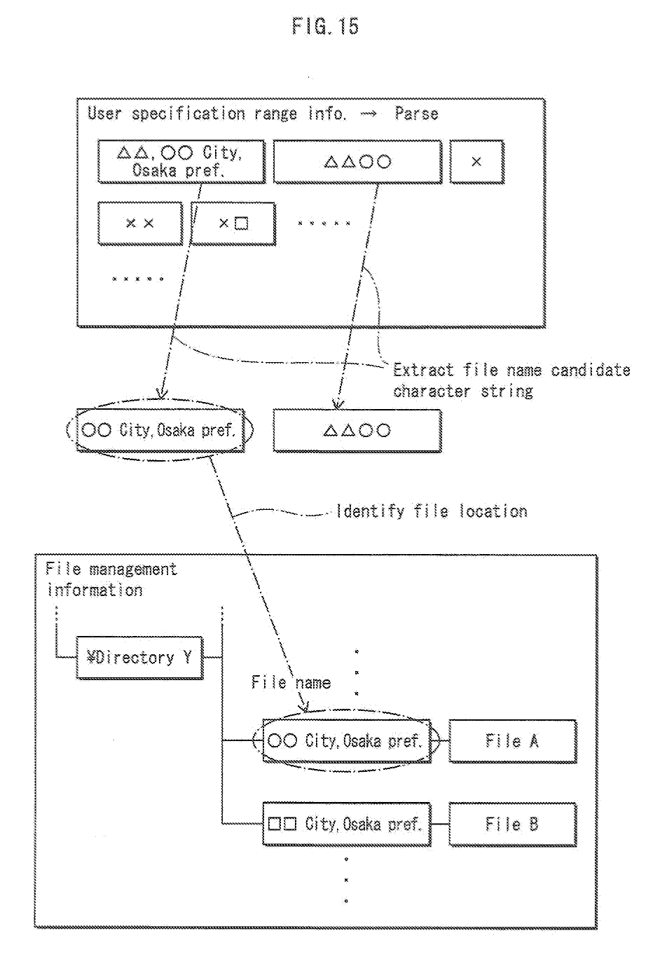

In sum, in the file search processing in accordance with this embodiment, as shown in FIG. 15, after user specification range information has been parsed, a character string that is to be a candidate of a file name is extracted, and the file name that matches the file name candidate character string is searched for, and the location of a file having the file name is identified with the use of the file management information.

<3-3> Description of Operation according to Specific Example

The operation of the mobile phone 100 in accordance with this embodiment is described with the use of a specific example.

The following describes an example of identifying a file having a file name that matches a character string contained in information displayed within the user specification range 506a (user specification range information) in the first touch panel 110 shown in FIG. 6 and attaching the identified file to an electronic mail.

When a user puts his finger at a position on the first touch panel 110, the first touch panel 110 outputs touch point data, which shows the physical coordinate values (50,200) of the position to the processor 170.

The detection unit 141 detects input of the touch point data to the processor 170, thereby detecting the first touch panel 110 is in the touch status (see Step S2 in FIG. 5).

When the detection unit 141 detects that the first touch panel 110 is in the touch status, the message issuance unit 142 issues a PRESS message, which includes the physical coordinate values (50, 200) of the point and the touch panel identification information showing that the physical coordinate values are included in the first touch panel 110, to the display processing unit 153 and the user specification range information extraction unit 156 (see Step S3 in FIG. 5).

Here, the coordinate conversion unit 143 converts the physical coordinate values (50, 200) to the logical coordinate values (50, 200) based on the touch position data inputted via the first touch panel 110, and stores data showing the logical coordinate values (50, 200) in the coordinate storage unit 130. Here, since the physical coordinate values are (50, 200), and since the touch panel identification information indicates the first touch panel 110, the logical coordinate values result in (50, 200).

Next, the detection unit 141 judges whether the first touch panel 110 has been changed from the touch status to the detach status (see Step S4 in FIG. 5).

It is judged that the first touch panel 110 is maintained in the touch status while the user is performing a drag operation on the first touch panel 110 (see Step S4: No in FIG. 5), and the message issuance unit 142 issues a MOVE message to the display processing unit 153 (see Step S5 in FIG. 5).

Here, the coordinate conversion unit 143 converts the physical coordinate values (80, 200) to the logical coordinate values (80, 200) based on the touch position information inputted via the first touch panel 110, and stores data showing the logical coordinate values (80, 200) in the coordinate storage unit 130. Here, since the physical coordinate values are (80, 200) and the touch panel identification information indicates the first touch panel 110, the logical coordinate values result in (80, 200).

After this, as long as the first touch panel 110 is in the drag status (i.e. a status where the first touch panel 110 is maintained in the touch status), the judging processing (Step S4 in FIG. 5) and the issuance of MOVE messages to the display processing unit 153 by the message issuance unit 142 (Step S5 in FIG. 5) are repeated at regular intervals (every 1/60 second in the embodiment).

Here, the display processing unit 153 performs the display on the first touch panel 110 so as to indicate that the characters displayed in the user specification range 506a defined as follows are specified by the user. The user specification range 506a is defined as a rectangular range including a line connecting a position (first point) specified by the physical coordinate values (50, 200) in a PRESS message and touch panel identification information showing that the physical coordinate values (50, 200) are included in the first touch panel 110 and a position (second point) specified by the physical coordinate values (80, 200) included in a MOVE message and touch panel identification information showing that the physical coordinate values (80, 200) are included in the first touch panel 110.

Here, the display processing unit 153 controls the first display unit 111 of the first touch panel 110 based on the physical coordinate values (50, 200) and (80, 200) contained in the PRESS message and the MOVE message and the touch panel identification information showing that the physical coordinate values (50, 200) and (80, 200) are in the first touch panel 110, thereby changing the display content of the first touch panel 110.

On the other hand, when it is judged that the first touch panel 110 has been changed from the touch status to the detach status (Step S4: Yes in FIG. 5) because the finger of the user is detached from the first touch panel 110, the message issuance unit 142 issues a MOVE message to the display processing unit 150 and the user specification range information extraction unit 156. The user specification range information extraction unit 156 extracts user specification range information contained in the user specification range 506a on the assumption that a rectangular range (see FIG. 7), which includes the line connecting the position (first point) specified by the physical coordinate values (50, 200) included in the PRESS message and the touch panel identification information that shows the physical coordinate values (50, 200) are in the first touch panel 110 and the position (second point) specified by the physical coordinate values (80, 200) included in the MOVE message and the touch panel identification information that shows the physical coordinate values (80, 200) are in the first touch panel 110, is the user specification range 506a, and stores the user specification range information in a temporary storage unit in the storage unit 160 (see Step S6 in FIG. 5).

Next, the search unit 151 searches the plurality of files having been stored in the storage unit 160 for a file having a file name that matches a character string in the user specification range information (see Step S7 in FIG. 5).

Here, as shown in FIG. 8A, the storage unit 160 stores therein the plurality of files, such as a file constituted from map image data (map image data A) showing a map around a predetermined area (ΔΔ, ∘∘ city, Osaka Pref.) and having the file name 703 which is the name of the predetermined area, and a file constituted from photo image data (photo image data B) of a certain person and having the file name 704 which is the name of the person (Yamada Taro).

Next, the search unit 151 judges whether the file having the file name containing the character string in the user specification range information has been identified (see Step S8 in FIG. 5).

When judging that the file name containing the character string in the user specification range information cannot be identified (see Step S8: No in FIG. 5), the search unit 151 terminates the operation for attaching a file stored in the storage unit 160 to the reply mail.

On the other hand, when the search unit 151 judges that the file having the file name 705 that matches the character string (ΔΔ, ∘∘ city, Osaka Pref.) contained in the user specification range information can be identified (see Step S8: Yes in FIG. 5), the display processing unit 153 displays the content of the file constituting from map image data showing a map around the predetermined area (ΔΔ, ∘∘ city, Osaka Pref.) on the second touch panel 120 (see Step S9 in FIG. 5).

Next, the attaching processing unit 152 judges whether the user has performed an attaching operation for attaching the file identified by the search unit 151 to an electronic mail via the second touch panel 120 (see Step S10 in FIG. 5).

The attaching operation is performed as follows as shown in FIG. 10. A user puts his finger on the second touch panel 120, and slides his finger for a predetermined distance in a direction (upward direction) toward the first touch panel 110 with his finger on the second touch panel 120.

When the attaching processing unit 152 judges that the user has performed attaching operation (see Step S10: Yes in FIG. 5), the attaching processing unit 152 attaches the file identified by the search unit 151 to the electronic mail (see Step S11 in FIG. 5).

On the other hand, when the attaching processing unit 152 judges that the user has not performed the attaching operation (see Step S10: No in FIG. 5), the judgment unit 155 judges whether five seconds have passed since the start of the display of the map image on the second touch panel 120 (see Step S12 in FIG. 5).

When the judgment unit 155 judges that five seconds have passed since the start of the display of the map image on the second touch panel 120 (see Step S12: Yes in FIG. 5), the file identified by the search unit 151 is attached to the electronic mail (see Step S11 in FIG. 5).

On the other hand, when the judgment unit 155 judges that five seconds have not passed since the start of the display of the map image on the second touch panel 120 (see Step S12: No in FIG. 5), the image creation unit 154 judges whether the user has put his finger on the input start button 803 displayed on the second touch panel 120 shown in FIG. 9 (whether start of file creation processing has been inputted) (see Step S13 in FIG. 5).

When the image creation unit 154 judges that the user has not put his finger, a stylus pen or the like on the input start button 803, (see Step S13: No in FIG. 5), the attaching processing unit 152 judges again whether the file identified by the search unit 151 has been attached to the electronic mail (see Step S10 in FIG. 5).

On the other hand, when the image creation unit 154 judges that the user has put his finger, a stylus pen or the like on the input start button 803 (see Step S13: Yes in FIG. 5), the image creation unit 154 activates a paint tool application stored in the storage unit 160, thereby starting to create a file (see Step S14 in FIG. 5).

Next, as shown in FIG. 11, for example, when a user draws an image 1001 of a circle, a character string “here” and an arrow each showing the current location, etc of the user on the second touch panel 120 in order to display the current location, the image creation unit 154 creates a new file based on the map image data constituting the file identified by the search unit 151 and the image data 1001 inputted by the user (see Step S14 in FIG. 5).

Next, the attaching processing unit 152 judges whether the user has performed the attaching operation for attaching the new file to the electronic mail via the second touch panel 120 (see Step S10 in FIG. 5).

Here, when the attaching processing unit 152 judges that data has been attached to the electronic mail (see Step S10: Yes in FIG. 5), the data displayed on the second touch panel 120 is attached to the electronic mail (see Step S11 in FIG. 5).

After the file has been attached to the electronic mail, as shown in FIG. 12, an icon 1101 indicating the file is displayed on the attached file display area 504 of the reply mail screen 500. Also, after the file has been attached, the QWERTY keys 505 are displayed again on the second touch panel 120.

### Embodiment 2

The following describes the communication system pertaining to the present invention.

<1> Overview

The communication system in accordance with this embodiment includes the mobile phone 100, a server device 20 being connected to the mobile phone 100 via a network. A plurality of files each having a unique name are stored both in the storage unit 160 provided in the mobile phone 100 and a server built-in storage unit 260 provided in the server device. First, the plurality of files stored in the storage unit 160 of the mobile phone 100 are searched for a file having a file name that matches a character string contained in information in the user specification range 506a (hereinafter, referred to as “user specification range information”) contained in the first touch panel 110 of the mobile phone 100. When the file is not detected in the storage unit 160, then the plurality of files stored in the server built-in storage unit 260 of the server device 200 are searched.

<2> Configuration

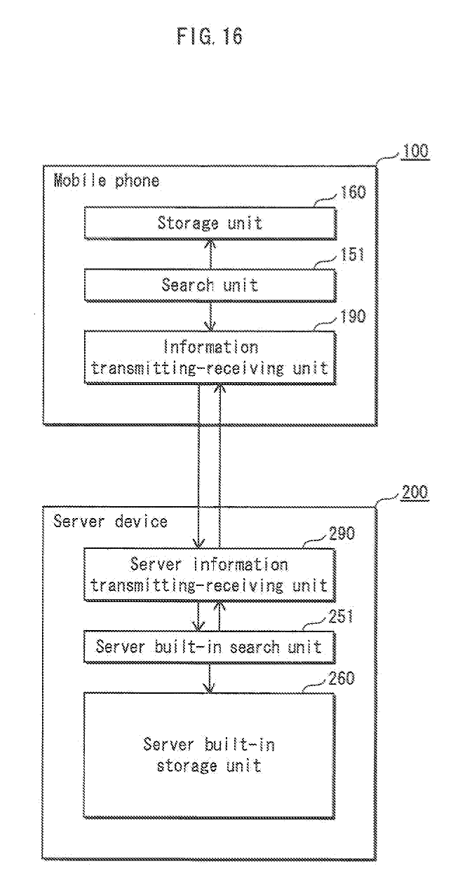

FIG. 16 shows the configuration of the communication system of this embodiment. The communication system of this embodiment includes the mobile phone 100, which is a communication terminal device, and the server device 200 connected to the mobile phone via a network.

The mobile phone 100 of this embodiment has basically identical configuration as the mobile phone 100 of Embodiment 1, except that the mobile phone of this embodiment includes an information transmitting-receiving unit 190 for transmitting information displayed in the user specification range 506a (hereinafter, referred to as “user specification range information”) and receiving information transmitted from the server device 200. Note that a description of the similar configuration to that of the mobile phone 100 of Embodiment 1 is omitted.

First, the storage unit 160 provided inside the mobile phone 100 stores therein first file management information, which will be described later.

The server device 200 is connected to the mobile phone 100 via a wired or wireless network. The server device 200 includes a server information transmitting-receiving unit 290 that receives user specification range information transmitted from the information transmitting-receiving unit 190 of the mobile phone 100 and transmits the information to the mobile phone 100, a server built-in storage unit 260 that stores therein a plurality of files each having a unique file name, arid a server built-in search unit 251 that searches the plurality of files stored in the storage unit 260 based on the user specification range information received at the server information transmitting-receiving unit 290. Also, the server built-in storage unit 260 stores therein second file management information, which will be described later.

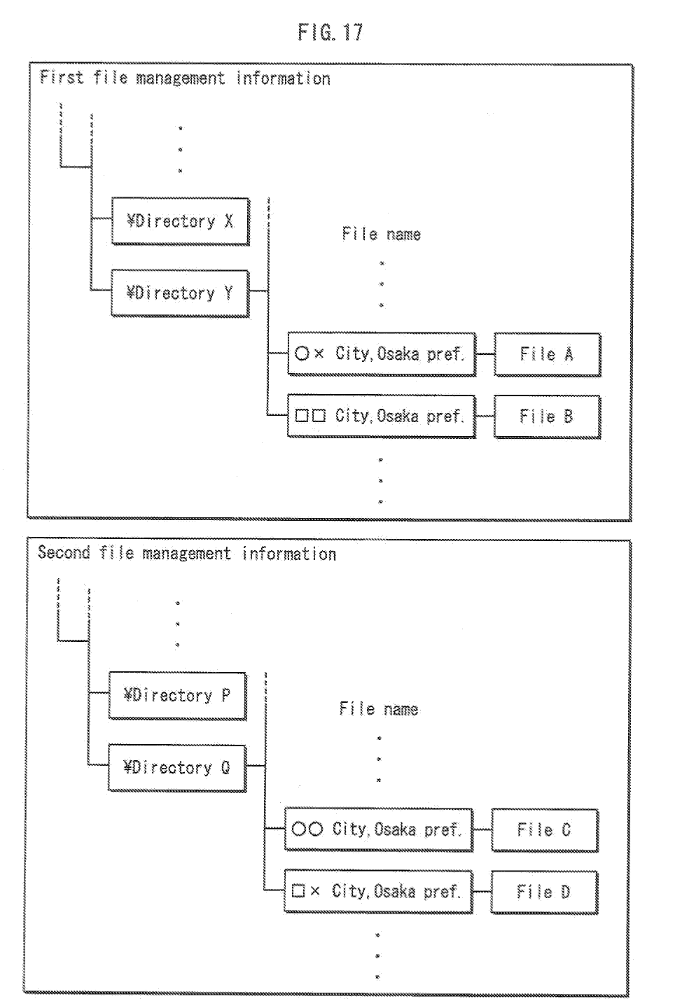

Here, the content of the first file management information and the second file management information is described based on FIG. 17.

The first file management information includes file names unique to the respective files stored in the storage unit 160 and information with regard to the location of the respective files. For example, as shown in FIG. 17, the first file management information includes information that shows a file A having a file name “∘x city, Osaka Pref.” is located in “¥Directory Y,” etc.

The second file management information includes file names unique to the respective files stored in the server built-in storage unit 260 and information with regard to the location of each file. For example, as shown in FIG. 17, the second file management information includes information that shows a file C having a file name “∘∘ city, Osaka Pref.” is located in “¥Directory Q,” etc.

<3> Operation

Next, a description is given of the operation of the communication system in accordance with this embodiment.

The operation of the mobile phone 100 that constitutes part of the communication system of this embodiment is substantially identical with that of Embodiment 1 except for the details of file search processing (Step S7 in FIG. 5). Accordingly, a description is given of the operation pertaining to file search processing by the mobile phone 100 that constitutes part of the communication system in accordance with this embodiment.

<3-1> Description of Operation Executed for File Search

Next, a detailed description is given of the operation of file search in accordance with this embodiment.

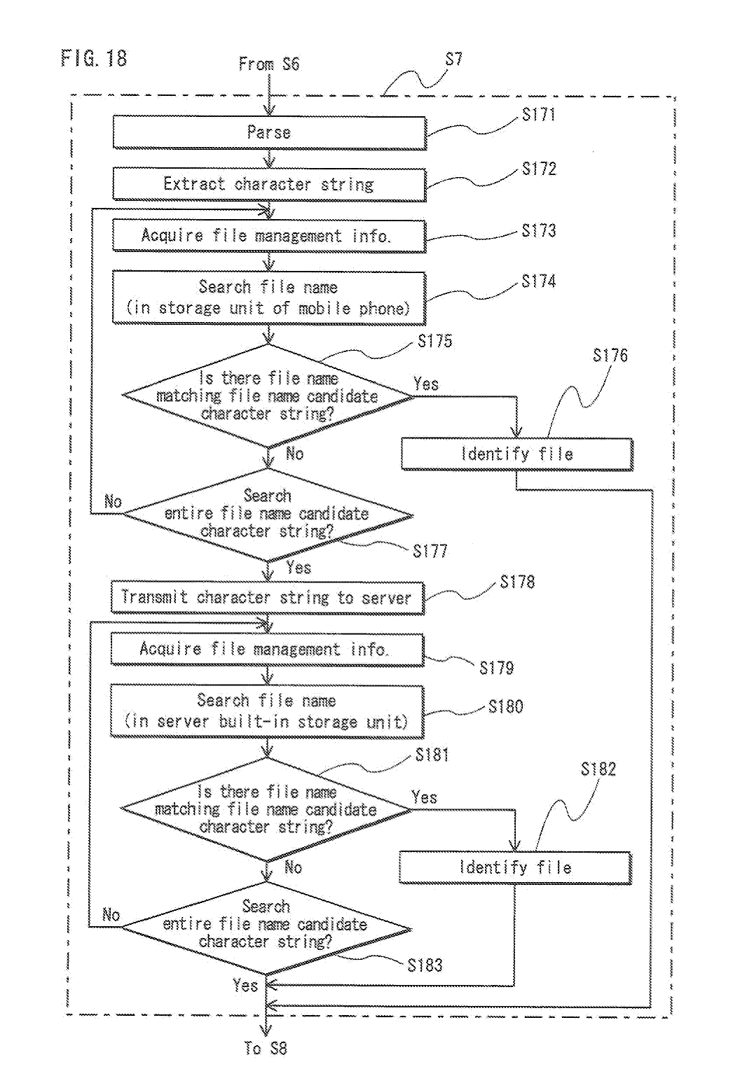

Here, FIG. 18 shows a flow chart showing file search processing performed in a case where user specification range information is constituted from a character string of a plurality of characters.

First, the search unit 151 in the mobile phone 100 parses a character string constituting user specification range information extracted by the user specification range information extraction unit 156, and identifies boundary positions in the construction of the character string (Step S71). Here, the parsing is performed with the use of Lexical functional grammar, for example.

Next, the search unit 151 extracts a character string constituting a potential noun used as a file name (hereinafter, referred to as file name candidate character string) based on the boundary positions in the construction of the character string (Step S172).

Next, the search unit 151 acquires the first file management information with regard to the plurality of files stored in the storage unit 160 (Step S173).

Next, the search unit 151 searches files stored in the storage unit 160 in the mobile phone 100 for a file having a file name that matches the file name candidate character string based on the first file management information (Step S174).

Next, the search unit 151 judges whether there is a file having the file name that matches the file name candidate character string in the storage unit 160 of the mobile phone 100 (Step S175).

When the search unit 151 judges that there is a file having file name that matches the file name candidate character string in the storage unit 160 of the mobile phone 100 in Step S175 (Step S175: Yes), the search unit 151 identifies the file based on the first file management information (Step S176), and the processing proceeds to Step 8.

On the other hand, when the search unit 151 judges that there is no file having the file name that matches the file name candidate character string in the storage unit 160 of the mobile phone 100 in Step S175 (Step 5175: Yes), the processing proceeds to the next Step S177.

Next, the search unit 151 judges whether the entire file name candidate character string has been searched (Step S177).

When the search unit 151 judges that the entire file name candidate character string have been searched in Step S177 (Step S177:Yes), the information transmitting-receiving unit 190 transmits data showing the file name candidate character string to the server information transmitting-receiving unit 290 of the server device 200 that is connected via the network (Step S178).

When it is judged that not the entirety of the file name candidate character string have been searched in Step S177 (Step S177: No), the search unit goes back to Step 173.

When the server device 200 receives data showing the file name candidate character string from the mobile phone 100, the server device built-in search unit 215 acquires the second file management information with regard to the plurality of files stored in the server built-in storage unit 260 (Step S179).

Next, the server device built-in search unit 251 searches for a file having the file name that matches the file name candidate character string in the server built-in storage unit 260 based on the second file management information (Step S180).

Next, the server device built-in search unit 251 judges whether there is a file having the file name that matches the file name candidate character string in the server built-in storage unit 260 (Step S181).

When the server device built-in search unit 251 judges that there is a file having the file name that matches the file name candidate character string in the server built-in storage unit 260 (Step S181: Yes), the server built-in search unit 251 identifies the file based on the second file management information (Step S182), and the processing proceeds to Step S8.

On the other hand, when the server device built-in search unit 251 judges that there is no file having the file name that matches the file name candidate character string in the server built-in storage unit 260 in Step S181 (Step S181:No), the processing proceeds to the next Step S183.

Next, the server device built-in search unit 251 judges whether the entire file name candidate character string extracted from the user specification range information has been searched (Step S183).

When it is judged that the entire file name candidate character string has been searched in Step S183 (Step S183: Yes), the processing proceeds to Step 8.

On the other hand, when it is judged that not the entirety of the character string has been searched in Step S183 (Step S183:No), the processing from Step S179 is performed again.

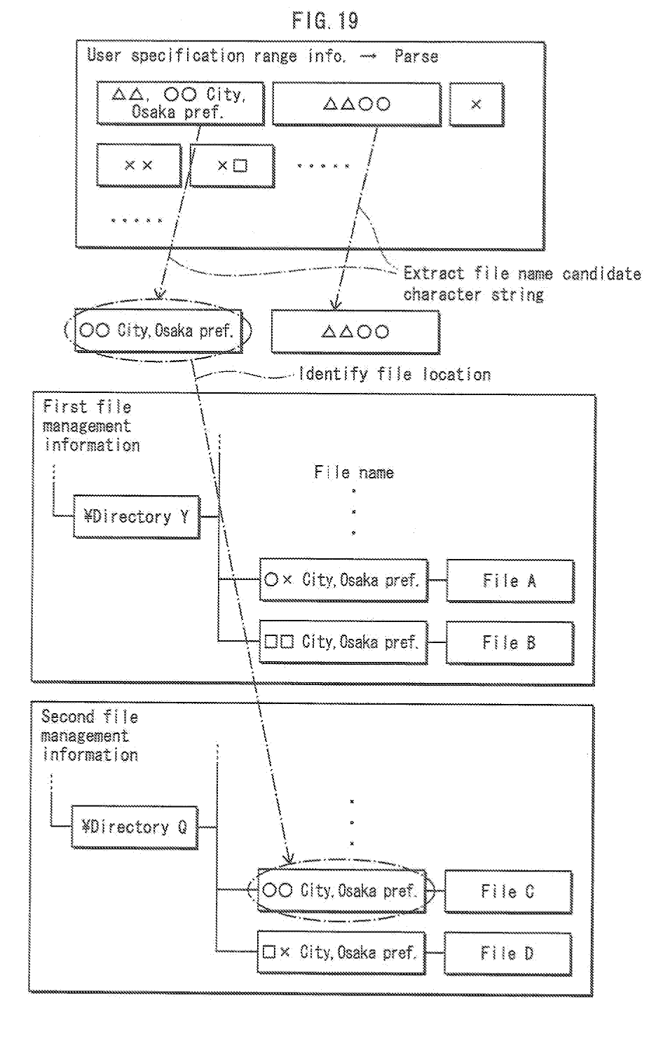

In sum, in the file search processing in accordance with this embodiment, as shown in FIG. 19, after user specification range information has been parsed, a file name candidate character string is extracted, and a file name that matches the file name candidate character string is searched for, and the location of a file having the file name is identified with the use of the first file management information and the second file management information.

[Modification]

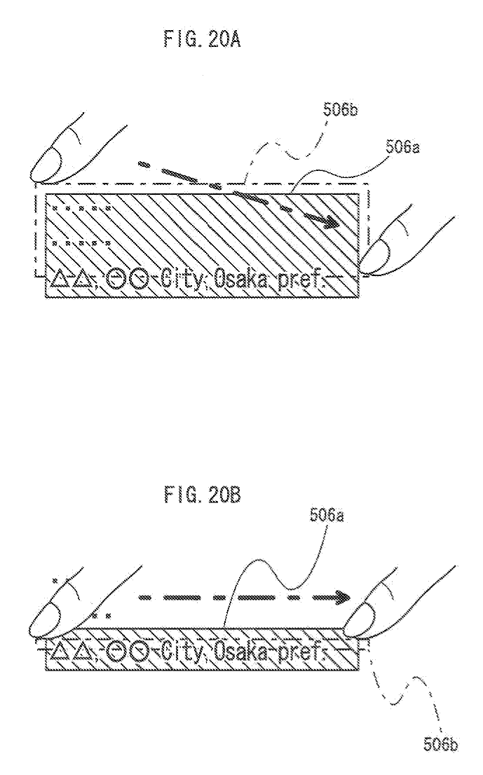

(1) In the above-mentioned Embodiment 1, as shown in FIG. 3, a description is given of an example where the range 506a in the first touch panel 110 can be specified as follows. First, a user puts his finger at one vertex (first point) in a rectangular range surrounding the entire character string a user attempts to specify. With his finger touching the first touch panel 110, the user slides his finger to another vertex (second point) that is opposed to the one vertex via the center of the range. However, the present invention is not limited to the example. As shown in FIG. 20A, even if a user specifies a rectangular range 506b that includes only part of the character string the user attempts to specify, the user can specify the rectangular range 506a that surrounds the entire character string the user attempts to specify.

In this case, the judgment unit 155 monitors the physical coordinate values of the first and the second points. The judgment unit 155 judges whether the character string is included in the user specification range based on the relative positional relationship between the first point or the second point in an area where one line of the character string is displayed.

Also, as shown in FIG. 20B, when the character string a user attempts to specify is displayed within one line, the user can specify the range 506a including the character string by sliding his finger along the line from the top position (first point) to the end position (second point) of the character string.

In this case, the judgment unit 155 monitors the physical coordinate values of the first and the second points. When the judgment unit 155 judges that the difference between the y coordinate of the first point and the y coordinate of the second point is smaller than the width of the one line of the character string, the judgment unit 155 assumes a range including the character string that includes the line connecting the first point and the second point as the user specification range 506a.

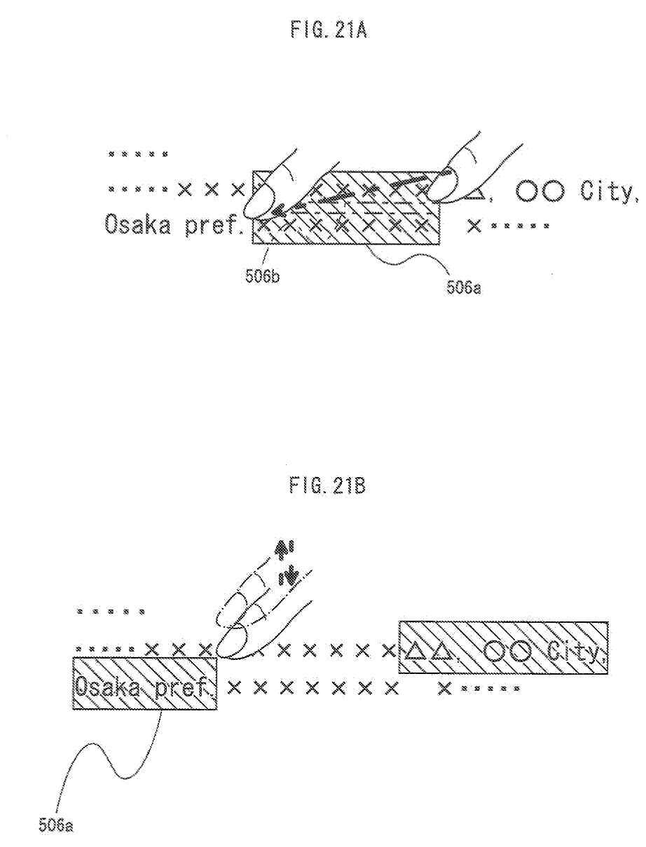

(2) According to Embodiment 1, a description is given of an example where an area between the first point and the second point is defined as the user specification range 506a as shown in FIG. 3. However, as shown in FIG. 21, even if the user specification range information is composed of a character string and if a character string a user attempts to specify is displayed across two lines, the character string can be specified. Here, as shown in FIG. 21A, first, a user puts his finger on the top portion of the character string displayed across two lines on the first touch panel 110, and slides his finger to the end portion of the character string. Then, after the user once moves his finger from the first touch panel, the user puts his finger again at the end portion of the character string within the predetermined time. Thus, the user can specify the character string as shown in FIG. 21B.

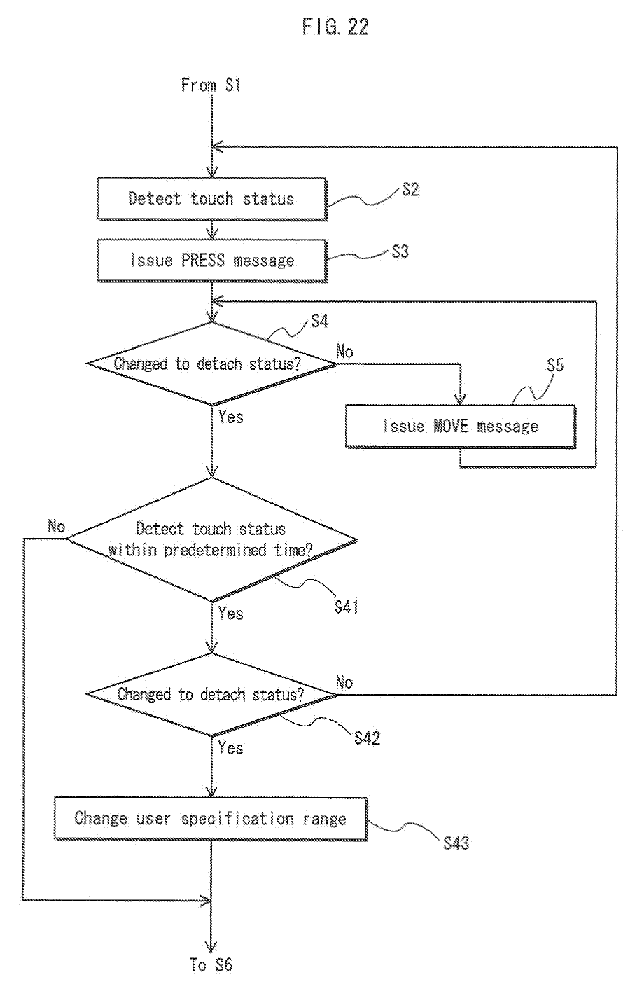

Here, a description is given of the operation in accordance with this modification. Part of a flow chart of the operation in accordance with this modification is shown in FIG. 22. The modification is different from the aforementioned Embodiment 1 in that additional processing intervenes between Step S4 and Step S6 in the flow chart shown in FIG. 5. Note that a description of the operation in the flow chart common to Embodiment 1 is omitted.

According to the mobile phone 100 of the modification, the storage unit 160 stores therein the physical coordinate values (hereinafter, referred to as reference coordinate values) of two vertexes of each of the first touch panel 110 and the second touch panel 120 (points a, b, c and d in FIG. 1).

When the aforementioned operation is performed as shown in FIG. 21B, the judgment unit 155 instructs the display processing unit 153 and the user specification range information extraction unit 156 to change from the user specification range 506a to an area containing the character string displayed across two lines.

When the detection unit 141 judges that the first touch panel 110 or the second touch panel 120 in the touch status is changed to be in the detach status in Step S4 (Step S4:Yes), the detection unit 141 judges whether the first touch panel 110 or the second touch panel 120 in the detach status has been changed to be in the touch status in response to user's touch of the first touch panel 110 or the second touch panel 120 with his finger, a stylus pen or the like for a predetermined time (e.g., one second) (Step S41).

When the detection unit 141 judges that the first touch panel 110 or the second touch panel 120 has not been changed to be in the touch status in Step S41 (Step S41: No), the processing proceeds to Step S6 (extraction of user specification range information).

On the other hand, when the detection unit 141 judges that the first touch panel 110 or the second touch panel 120 has been changed to be in the detach status in Step S41 (Step S41: Yes), the detection unit 141 judges again whether the first touch panel 110 or the second touch panel 120 has been changed to be in the detach status because a user has moved his finger, a stylus pen or the like away from the first touch panel 110 or the second touch panel 120 within the predetermined time (e.g. one second) (Step S42).

When the detection unit 141 judges that the first touch panel 110 or the second touch panel 120 has not yet been changed to be in the detach status in Step S42 (Step S42: No), the processing proceeds to Step S2 (detection of touch status).

On the other hand, when the detection unit 141 judges that the first touch panel 110 or the second touch panel 120 has been changed to be in the detach status (Step S42: Yes), the judgment unit 155 instructs the display processing unit 153 and the user specification range information extraction unit 156 to change from the user specification range 506a to an area containing the character string displayed across two lines as shown in FIG. 21B (Step S43).

Next, in Step S6, based on the physical coordinate values contained in the PRESS message and the MOVE message, touch panel identification information and the reference coordinate values, the display processing unit 153 displays, as the user specification range 506a, the area containing the character string displayed across two lines. Next, based on the physical coordinate values contained in the PRESS message and the MOVE message, the touch panel identification information and the reference coordinate values, the user specification range information extraction unit 156 extracts user specification range information, assuming the area containing the character string displayed across two lines as the user specification range 506a.

According to this modification, even a character string displayed across two lines can be specified, which enhances the operability for a user.

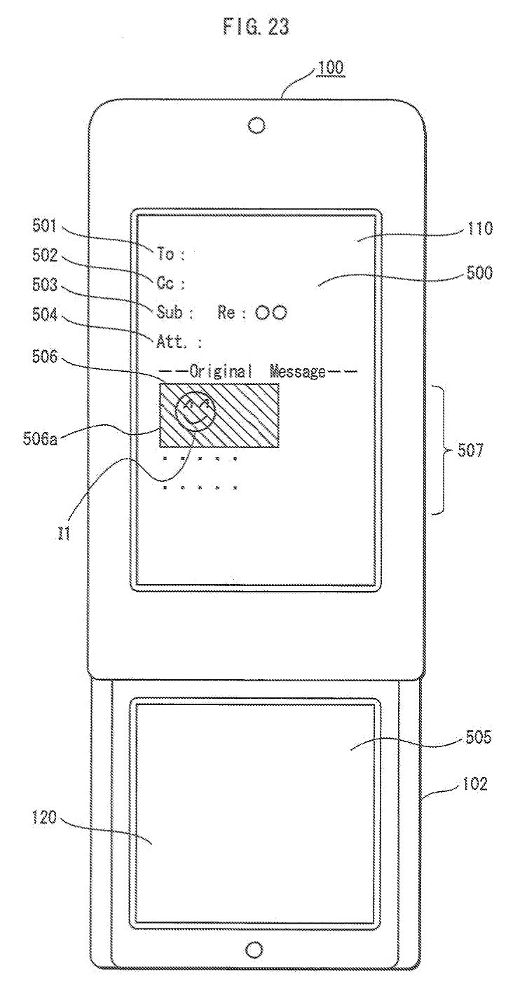

(3) In the above-mentioned Embodiment 1, a description is given of an example where the search unit 151 that partially constitutes the file identification unit 157 identifies a file with the use of its file name. However, the present invention is not limited to this. For example, as shown in FIG. 23, information displayed within the user specification range 506a on the first touch panel 110 may include an icon Ia that is associated with a predetermined file, and the search unit 151 may identify the predetermined file that is associated with the icon that partially constitutes the information displayed within the user specification range 506a among the plurality of files each having a unique name.

According to this modification, since the content of a file can be displayed as a picture on the first touch panel 110, a user can easily comprehend the content of the file without checking the content with the second touch panel 120.

(4) According to the above-mentioned Embodiment 1, after a user specifies a range by operating the first touch panel 110, as soon as the result of the judgment of the operation status of the first touch panel 110 (see Step S4 in FIG. 5) shows that the first touch panel 110 is changed from the touch status to the detach status, the search unit 141 starts to search the user specification range information (see Step S6 in FIG. 5). However, instead of this, as shown in Fie. 24, the search unit 141 may start the search processing when a user slides his finger for a predetermined distance in a direction toward the second touch panel 120 with his finger on the first touch panel 110. Note that in this modification, a description is given of an example where the search unit 141 starts search processing in response to the user operating of sliding his finger in the direction toward the second touch panel 120 with his finger on the first touch panel 110. However, a user does not need to slide his finger in the direction toward the second touch panel 120. A user may slide his finger in other directions, or in a plurality of directions that are arbitrarily combined. Also, the search unit 141 may start the search processing when a user slides his finger to draw a certain shape on the first touch panel 110, or touching the first touch panel 110 for a plurality of times. Alternatively, an arbitrary combination of these operations is applicable.

According to this modification, a user can determine, at his discretion, the timing for the search unit 141 to perform the search processing. Accordingly, even if a user specifies a wrong range, he can specify a range again.

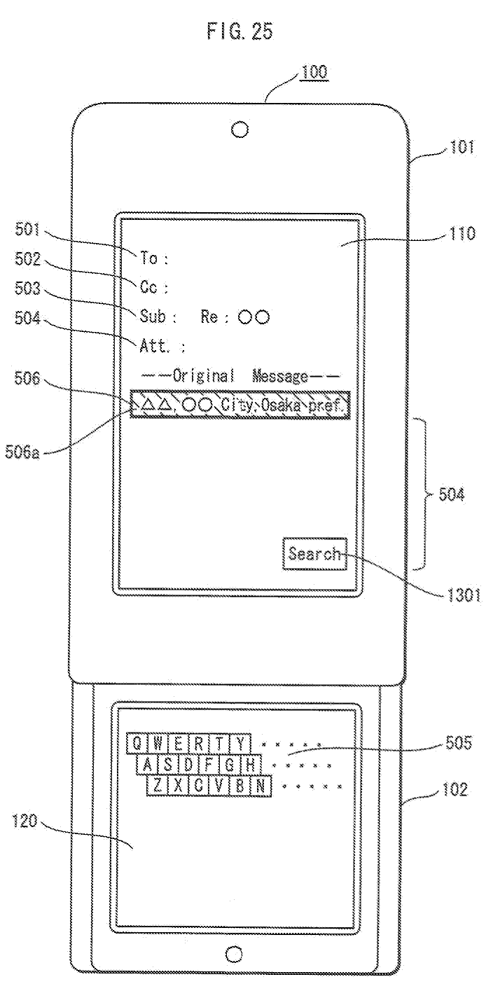

(5) Furthermore, in this modification, as shown in FIG. 25, the display processing unit 153 may display a search button 1301 on the first touch panel 110, and the search unit 141 may start the search processing in response to user's touch of the search button 1301 with his finger after the judgment result (see Step S4 in FIG. 5) shows that the first touch panel 110 has been changed from the touch status to the detach status.

According to this modification, the search processing is not performed unless the user puts a predetermined object at a position where the search button is displayed, which prevents a user from performing an erroneous operation.

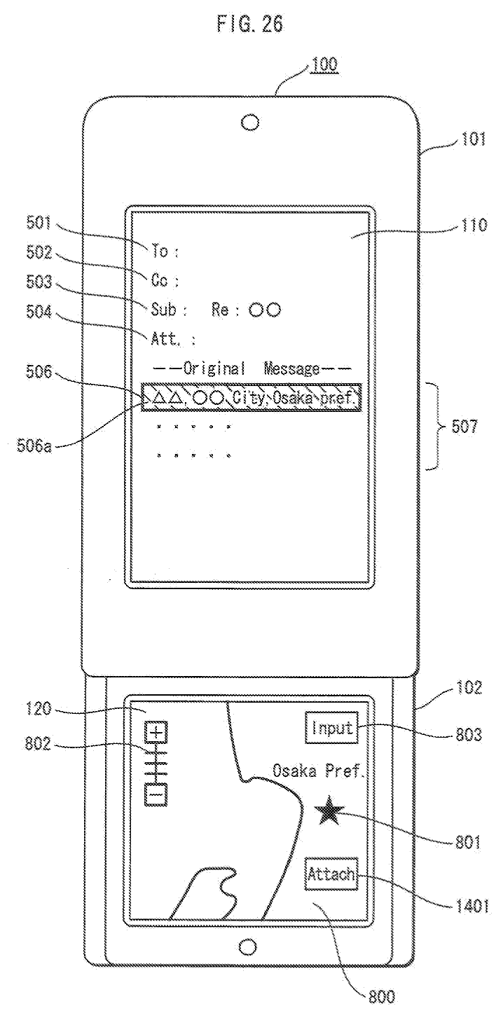

(6) In the above-mentioned modification (3), as shown in FIG. 10, a description is given of an example where that attaching processing for attaching a file to an electronic mail is started when a user puts his finger on the second touch panel 120 and slides his finger for a predetermined distance in a direction toward the first touch panel 110 with his finger on the second touch panel 120. However, the present invention is not limited to this. As shown in FIG. 26, the display processing unit 153 may display the attach button 1401 on the second touch panel 120, and the file attaching processing may be started in response to the user operation for putting his finger or the like on the attach button 1401. According to this modification, the file attaching processing is not performed unless the user puts a predetermined object at the position where the attach button 1401 is displayed, which prevents a user from performing an erroneous operation.

Note that in this modification, a description is given of an example where a user puts his finger or the like on the attach button 1401 to start the attaching processing. However, the present invention is not limited to this. The attaching processing may be started when a user slides his finger to draw a certain shape on the second touch panel 120, or touches the second touch panel 120 for a plurality of times. Alternatively, an arbitrary combination of these operations is applicable.

Note that in the above-mentioned modification (3), a description is given of an example where the finger put on the second touch panel 120 is slid to the direction toward the first touch panel 110. However, the direction for sliding a finger is not limited to the direction toward the first touch panel 110. A finger may be slid in other direction. Alternatively, an arbitrary combination of a plurality of directions is also applicable.

(7) In the above-mentioned Embodiment 1 and Embodiment 2, a description is given of an example where the search unit 151 identifies a file based on its file name. However, the present invention is not limited to this. The user specification range information may include a character string, and the search unit 151 may identify a file containing file identification data that matches the character string contained in the user specification range information among a plurality of files each having a unique file identification data each constituted from a character string. According to this modification, since one file may include a plurality of types of file identification data, it is possible to identify one file among a plurality of types of character strings included in the user specification range information.

(8) In the above-mentioned Embodiment 1, a description is given of a case where a reply mail application is activated in Step S1. However, a sent-mail application or a forwarded-mail application may replace the replay mail application in Step S1. Alternatively, a memo pad, a web browser or the like may be activated instead of the replay mail application. In this case, when the processing for attaching a file whose content is displayed on the second touch panel 120 to an electronic mail has been executed (see Step S11 in FIG. 5), the mobile phone 100 automatically activates a mail application, thereby attaching the file to the electronic mail.

(9) In the above-mentioned Embodiment 1, a description is given of a case where a file constituted from map image data or photo image data is attached to an electronic mail. However, the present invention is not limited to this. For example, a file constituted from various kinds of data such as data detected as a result of web search, photo image data, moving picture data, music data, text data, or table data may be attached.

(10) In the above-mentioned Embodiment 1, a description is given of an example where the image creation unit 154 performs image creation processing for changing part of map image data displayed on the second touch panel 120 based on data inputted by a user. However, the present invention is not limited to this. For example, a user may combine other image data edits such as changing the tone, increasing and decreasing in size to perform image creation processing on the map image data displayed on the second touch panel 120.

(11) In the above-mentioned Embodiment 1, a description is given of an example where the image creation unit 154 activates a drawing application stored in the storage unit 160 in response to user's touch of the input start button 603 with a stylus pen or the like. However, the present invention is not limited to this. A drawing application may be activated in response to user's touch of an arbitrary portion of the second touch panel 120 with a stylus pen or the like.

(12) In the above-mentioned Embodiment 1, for example, when a drawing application is activated, an icon (unillustrated) for displaying an image is displayed on the second touch panel 120, and a user may perform drawing with the icon. Alternatively, an image creation menu screen (unillustrated) that enables a user to select the color, the line width, and the fixed image is displayed, and a user may create an image with the use of the menu screen.

(13) In the above-mentioned Embodiment 2, a description is given of an example as follows. A plurality of files each having a unique file name are stored in the storage unit 160 both in the mobile phone 100 and the server built-in storage unit 260. First, a file having a file name that matches a file name candidate character string extracted from the user specification range information is searched for in the storage unit 160 of the mobile phone 100. If the file cannot be specified in the mobile phone 100, then the files in the server built-in storage unit 260 are searched. However, the present invention is not limited to this, and the following is also applicable. A plurality of files are stored only in the server built-in storage unit 260, and a file having a file name that matches a file name candidate character string extracted from the user specification range information may be searched for in the server built-in storage unit 260. Note that files stored in the server built-in storage unit 260 may be constituted from photo image data, moving picture data, music data, text data, table data or the like.

(14) In the above-mentioned Embodiment 2, a description is given of an example where the search unit 151 of the mobile phone 100 parses the character string constituting the user specification range information. However, the present invention is not limited to this. Using the information transmitting-receiving unit 190, the mobile phone 100 may transmit the entire character string constituting the user specification range information to the server device 200, and the server built-in search unit 251 may parse the character string constituting the user specification range information.

(15) In the above-mentioned Embodiment 2, a description is given of an example where the server built-in search unit 251 performs search in the server built-in storage unit 260. However, the present invention is not limited to this. The server device 200 may be connected to the Internet, and the server built-in search unit 251 performs web search using a character string in the user specification range information as a keyword and may create a file constituted from data with regard to location information of the web detected by the web search. Also, for example, the server built-in storage unit 260 may perform web search using a character string in the user specification range information as a keyword, and may create a file constituted from data with regard to the top-ranked web location information in a list of a plurality of data pieces with regard to the web location information detected by the web search. Alternatively, the server built-in storage unit 260 may create a file constituted from a data piece selected by a user from a list of a plurality of data pieces with regard to the web location information detected by the web search.

<Supplementary Note>

<1> Supplementary Note with regard to Modification

As above, a description is given of the mobile phone 100 pertaining to the present invention based on the embodiments and the modifications. However, the present invention may be modified as follows. Needless to say, the present invention is not limited to the mobile phone shown in the embodiments and the modifications.

(1) In the embodiments and the modifications, a description is given of an example where the message issuance unit 142 issues a PRESS message or a MOVE message containing the physical coordinate values and the touch panel identification information to the display processing unit 153 and the user specification range information extraction unit 156. However, the present invention is not limited to this. The PRESS message or the MOVE message issued by the message issuance unit 142 may contain the logical coordinate values stored in the coordinate storage unit 130, for example.

Also, the predetermined operation by the message issuance unit 142 on the first touch panel 110 and the second touch panel 120 can determine which of the physical coordinate values and the touch panel identification information, or the logical coordinate values to be contained in the PRESS message or the MOVE message.

(2) In the above-mentioned Embodiment 1, a description is given of an example where a plurality of files as shown in FIG. 8A are stored in the storage unit 160. However, the present invention is not limited to this. For example, as shown in FIG. 8B, the storage unit 160 may store therein a plurality of files, such as a file that has the file name 705 that is constituted from data showing the latitude & longitude information ((latitude, longitude)=(X1, Y1)) of a predetermined area (1-2-3 □x, ∘∘ city, Osaka. Pref.) and that is the name of the predetermined area (1-2-3 □x, ∘∘ city, Osaka Pref.) or a file that is constituted from data showing the latitude & longitude information ((latitude, longitude)=(X2, Y2)) of a predetermined facility (Osaka Castle) and that is the name of the predetermined facility (Osaka Castle), and a wide-area map image file constituted from wide-area map image data.

In this case, the mobile phone 100 is required to include an image cutting-out unit (unillustrated) for generating map image data of a neighboring area that includes an area specified by the latitude & longitude information from the wide-area map image data. The image cutting-out unit may be implemented by execution of a control application stored in the storage unit 160 by the processor 170.

In the modification, when the search unit 151 identifies the file having the file name 705 that matches the character string (1-2-3 □x, ∘∘ city, Osaka Pref.) contained in the user specification range information in Step S9 in FIG. 5, the image cutting-out unit (unillustrated) generates a new image file by cutting out map image data of the neighboring area including the area specified by the latitude & longitude information data 709 of the file from the wide-area map image data based on the latitude & longitude information data 709 of the file. Next, the display processing unit 153 displays the content of the new image file on the second touch panel 120.

(3) In the above-mentioned Embodiment 1, a description is given of an example where the search unit 151 searches for a file having a file name that matches a character string contained in information displayed within the user specification range 506a. However, the present invention is not limited to this. For example, the search unit may search for a file name including the character string (e.g., character string that matches a forward portion of the file name or character string that matches backward portion of the file name).

When the storage unit 160 stores therein a plurality of files each including a character string contained in information displayed within the user specification range 506a. A list of a plurality of files each having the character string may be created, and the search unit 151 may perform priority processing as necessary for preferentially identifying a file, registered at the top of the list, to be attached to an electronic mail among the plurality of files each having the character string.

(4) In the above-mentioned embodiments and the modifications, the message issuance unit 142, the detection unit 141, the coordinate conversion unit 143, the display processing unit 153, the user specification range information extraction unit 156, the search unit 151, the attaching processing unit 152, the judgment unit 155 and the image creation unit 154 are implemented in response to the execution, by the processor 170, of the display control application and the control program stored in the storage unit 160. However, the present invention is not limited to this. The message issuance unit 142, the detection unit 141, the coordinate conversion unit 143, the display processing unit 153, the user specification range information extraction unit 156, the search unit 151 are entirely or partially implemented on an integrated circuit composed of one or more of processing devices.

(5) In the above-mentioned embodiments and modifications, a description is given of the mobile phone 100 by way of example of the communication terminal device of the present invention. However, the present invention is not limited to this. Other device than the mobile phone is applicable as long as the device is provided with a touch panel. For example, a mobile information terminal or the like is also applicable.

(6) In the above-mentioned embodiments and modifications, a description is given of an example where the mobile phone 100 has two touch panels composed of the first touch panel 110 and the second touch panel 120. However, the present invention is not limited to this. One touch panel or three or more touch panels may be provided.

(7) In the above-mentioned embodiments and modifications, as shown in FIG. 1, a description is given of the slide-type mobile phone having the rectangular-plate-like first package and the rectangular-plate-like second package being slidably, in the longitudinal direction of the first package, attached to one surface of the first package in the thickness direction. However, the present invention is not limited to this. For example, a folding mobile phone as follows is also applicable. The folding mobile phone has two rectangular-plate-like packages (unillustrated) each having a window part (unillustrated) on one surface in the thickness direction. The two packages can face each other with their surfaces, each having the window part, are opposed to each other, and are rotatably fixed to each other at one ends thereof. When one of the packages is rotated around its one end for a half cycle with respect to the other package, the respective window parts of the first touch panel (unillustrated) and the second touch panel (unillustrated) are exposed, so that the folding mobile phone is in an operable state. Also, the mobile phone pertaining to the embodiments and the modifications may be a straight-type mobile phone provided with the first touch panel and the second touch panel arranged, in the longitudinal direction, on one surface, in the thickness direction, of one rectangular-plate-like package. Alternatively, the package may have other external appearance as long as the first touch panel and the second touch panel are provided. Alternatively, one touch panel provided on one surface of one package in the thickness direction is divided into two areas. One of the areas may be defined as the first touch panel and the other may be defined as the second touch panel.

(8) In the above-mentioned embodiments and modifications, a description is given of the mobile phone whose first touch panel and second touch panel are arranged in the vertical direction, seen from a user, in a normal usage state. However, the present invention is not limited to this. The first touch panel and the second touch panel may be arranged in the horizontal direction. In this case, the x coordinate of the logical coordinate values in the operation control coordinate system is determined in view of the width of the bezel provided between the first touch panel and the second touch panel.

(9) In the above-mentioned embodiments and modifications, a description is given of the mobile phone whose first touch panel and second touch panel are both arranged on one surface of the package in the thickness direction in a normal usage state. However, the present invention is not limited to this. For example, the first touch panel is provided on one surface of one rectangular-plate-like package in the thickness direction, and the second touch panel is provided on the other surface.

(10) In the above-mentioned embodiments and modifications, a description is given of the mobile phone having the first touch panel and the second touch panel each in a rectangular shape in a plan view arranged as follows. One side of the second touch panel toward the first touch panel is disposed parallel to one side of the first touch panel in the longitudinal direction, and the bezel is provided between the first touch panel and the second touch panel. However, the present invention is not limited to this. The following mobile phone is also applicable. A bezel is not provided between the first touch panel and the second touch panel that are each in a rectangular shape in a plan view, and the one side of the first touch panel in the longitudinal direction and the one side of the second touch panel toward the first touch panel are substantially in contact with each other. In this case, the y coordinate of the logical coordinate values in the operation control coordinate system is determined without consideration of the width of the bezel provided between the first touch panel and the second touch panel. Also, in the mobile phone whose first touch panel and second touch panel are arranged in the horizontal direction, no bezel between the first touch panel and the second touch panel is also applicable.

<2> Supplementary Note with regard to Function Effect

(1) The communication terminal device pertaining to the present invention has one or more touch panels, a display processing unit that display information on at least one of the touch panels, a file identification unit that identifies a target file according to information displayed within a user specification range in one of the touch panels, the user specification range being specified by a user operation of the one of the touch panels and a file transmission unit that transmits the target file identified by the file identification unit to an external device. The present invention can enhance the operability from identification of a file to transmission of the file to an external device.

(2) According to the communication terminal device pertaining to the present invention, the touch panels are constituted from a first touch panel and a second touch panel, and the display processing unit displays, on the first touch panel, the information displayed within the user specification range, and displays a content of the target file on the second touch panel after the file identification unit has identified the target file. With this, a user can specify a range with the first touch panel and check the content of the file identified by the file identification unit with the second touch panel, which enhances the usability of the communication terminal device.

(3) According to the communication terminal device pertaining to the present invention, when a user specifies a range in one of the touch panels by touching with a pointing means a first point in a vicinity of the range, and removing the pointing means from a second point after sliding motion to the second point, the file identification unit identifies, as the user specification range, an area including a line connecting the first point and the second point. According to the present invention, a user can specify the user specification range by merely putting an pointing means on the touch panel, which can enhance the operability.

(4) According to the communication terminal device pertaining to the present invention, information displayed within the user specification range in the touch panel includes a character string, and the file identification unit identifies a file having a file name matching the character string included in the information displayed within the user specification range as the target file among a plurality of files each having a unique file name. According to the present invention, since the content of a file identified by the file identification unit can be changed by changing its file name, the content of a file identified by the file identification unit can be relatively easily changed.

(5) According to the communication terminal device pertaining to the present invention, information displayed within the user specification range in the touch panel includes an icon at least associated with a file, and the file identification unit identifies the file associated with the icon included in the information displayed within the user specification range as the target file among a plurality of files According to the present invention, the content of a file can be displayed as a picture, which enables a user to easily comprehend the content of the file.

(6) According to the communication terminal device pertaining to the present invention, the file transmission unit transmits the target file to, the external device by transmitting an electronic mail to which the target file has been attached, and the communication terminal device further includes an attaching processing unit operable to attach the target file to the electronic mail. According to the present invention, a message can be transmitted to a receiver together with a file, which enhances the usability of the communication terminal device.

(7) According to the communication terminal device pertaining to the present invention, the attaching processing unit attaches the target file to the electronic mail in response to touch with the pointing means of at least one of the touch panels after the file identification unit has identified the target file. According to the present invention, a user can decide, at his discretion, the timing for the attaching processing unit to perform the file attaching processing, which enhances the usability of the communication terminal device.

(8) The communication terminal device pertaining to the present invention includes a file creation unit operable to create a new file according to data inputted by a user via the first touch panel or the second touch panel and to data constituting the target file identified by the file identification unit. According to the present invention, a new file created according to data inputted by a user can be transmitted, which enhances the usability of the communication terminal device.

(9) The mobile communication terminal device pertaining to the present invention has a function of transmitting and receiving electronic mails and has a communication terminal device described in the item (1) in “<8-2> Supplementary Note with regard to Function Effect.” The mobile communication terminal device according to the present invention can suppress the decrease in operability from the file identification to the file transmission.

(10) The mobile communication terminal device pertaining to the present invention has a function of transmitting and receiving electronic mails, and the file transmission unit transmits a file to an external device by transmitting an electronic mail to which the file has been attached. The communication terminal device having the attaching processing unit that attaches a file to an electronic mail and the file creation unit that creates a file according to data inputted by a user via the second touch panel and to data constituting the file identified by the file identification unit, as described in the item (3) in “<2> Supplementary Note with regard to Function Effect,” is provided A user can input data via the second touch panel while checking information displayed on the first touch panel, which can enhance the usability of the communication terminal device.

(11) The communication system pertaining to the present invention has the communication terminal device described in the item (1) in “<2> Supplementary Note with regard to Function Effect” and the server device connected to the communication terminal device via a network. The communication terminal device has an information transmission unit that transmits information displayed in the user specification range to the server device. The server device has a server built-in storage unit that stores therein a plurality of files and a server built-in search unit that searches the plurality of files stores in the server built-in storage unit. Since the server device according to the present invention has a server built-in storage unit for storing therein files and a server built-in search unit for searching for a file in user specification range information, larger-capacity files as well as a larger number of files can be handled. Accordingly, the present invention is more widely applicable.

### INDUSTRIAL APPLICABILITY

The present invention is applicable to an operation from the file identification to the file transmission.

### REFERENCE SIGNS LIST

100 mobile phone

101 first package

102 second package

103 speaker

104 microphone

110 first touch panel

111 first display unit

112 first input unit

120 second touch panel

121 second display unit

122 second input unit

141 detection unit

142 message issuance unit

151 search unit

152 attaching processing unit

153 display processing unit

154 image creation unit (file creation unit)

155 judgment unit

156 user specification range information extraction unit

160 storage unit

170 processor

506a user specification range

1. A communication terminal device comprising:
one or more touch panels;
a display processing unit operable to display information on at least one of the touch panels;
a file identification unit operable to identify a target file according to information displayed within a user specification range in one of the touch panels, the user specification range being specified by a user operation of the one of the touch panels; and
a file transmission unit operable to transmit the target file identified by the file identification unit to an external device.

2. The communication terminal device of claim 1, wherein
the touch panels are constituted from a first touch panel and a second touch panel, and
the display processing unit displays, on the first touch panel, the information displayed within the user specification range, and displays a content of the target file on the second touch panel after the file identification unit has identified the target file.

3. The communication terminal device of claim 2, wherein
when a user specifies a range in one of the touch panels by touching with a pointing means a first point in a vicinity of the range, and removing the pointing means from a second point after sliding motion to the second point, the file identification unit identifies, as the user specification range, an area including a line connecting the first point and the second point.

4. The communication terminal device of claim 3, wherein
the information displayed within the user specification range includes a character string, and
the file identification unit identifies a file having a file name matching the character string included in the information displayed within the user specification range as the target file among a plurality of files each having a unique file name.

5. The communication terminal device of claim 3, wherein
the information displayed within the user specification range includes an icon that is at least associated with a file, and
the file identification unit identifies the file associated with the icon included in the information displayed within the user specification range as the target file among a plurality of files.

6. The communication terminal device of claim 4, wherein
the file transmission unit transmits the target file to the external device by transmitting an electronic mail to which the target file has been attached, and
the communication terminal device further includes an attaching processing unit operable to attach the target file to the electronic mail.

7. The communication terminal device of claim 6, wherein
the attaching processing unit attaches the target file to the electronic mail in response to touch with the pointing means of at least one of the touch panels after the file identification unit has identified the target file.

8. The communication terminal device of claim 6, further comprising:
a file creation unit operable to create a new file according to data inputted by a user via the first touch panel or the second touch panel and to data constituting the target file identified by the file identification unit.

9. The communication terminal device of claim 1, being a mobile device and having a function of transmitting and receiving an electronic mail.

10. The communication terminal device of claim 3, wherein
the file transmission unit transmits the target file to the external device by transmitting an electronic mail to which the target file has been attached, and
the communication terminal device further includes:
an attaching processing unit operable to attach the target file to the electronic mail; and
a file creation unit operable to create a new file according to data inputted by a user via the second touch panel and to data constituting the target file identified by the file identification unit.

11. A communication system having the communication terminal device as defined in claim 1 and a server device that is connected to the communication terminal device via a network, wherein
the communication terminal device includes an information transmission unit operable to transmit information displayed in a user specification range in one of touch panels to the server device, the user specification range being specified by a user operation of the touch panels, and
the server device includes a server built-in storage unit that stores therein a plurality of files, and a server built-in search unit that searches the plurality of files stored in the server built-in storage unit.
